(19) United States
(12) Patent Application Publication
(10) Pub. No.: US 2025/0294538 A1
(43) Pub. Date: Sep. 18, 2025

(54) METHOD FOR CONFIGURING SUBBAND IN WIRELESS COMMUNICATION SYSTEM, AND DEVICE THEREFOR

(71) Applicant: WILUS INSTITUTE OF STANDARDS AND TECHNOLOGY INC., Gyeonggi-do (KR)

(72) Inventors: Geunyoung SEOK, Gyeonggi-do (KR); Minseok NOH, Gyeonggi-do (KR); Juhyung SON, Gyeonggi-do (KR); Jinsam KWAK, Gyeonggi-do (KR); Youngjoon YOON, Gyeonggi-do (KR)

(21) Appl. No.: 18/861,129

(22) PCT Filed: Apr. 28, 2023
(86) PCT No.: PCT/KR2023/005927

§ 371 Date: Oct. 28, 2024

(30) Foreign Application Priority Data
Apr. 28, 2022 (KR) 10-2022-0053010
Apr. 29, 2022 (KR) 10-2022-0053869
Aug. 12, 2022 (KR) 10-2022-0101468
Nov. 5, 2022 (KR) 10-2022-0146605
Dec. 16, 2022 (KR) 10-2022-0177640

(51) Int. Cl. H04W 72/0453; H04L 5/14; H04W 72/0446

(52) U.S. Cl. CPC H04W 72/0453; H04L 5/14; H04W 72/0446

(57) ABSTRACT

The present invention relates to a terminal that receives information about slots in a time division duplex (TDD) system, receives information about a plurality of subbands on frequency domain resources, and performs uplink transmission on resources within a subband that is determined to be a subband for uplink transmission on the basis of the information about the plurality of subbands.

### TECHNICAL FIELD

The present specification relates to a wireless communication system, and to a method for configuring a subband and a device therefor.

### BACKGROUND ART

After commercialization of 4th generation (4G) communication system, in order to meet the increasing demand for wireless data traffic, efforts are being made to develop new 5th generation (5G) communication systems. The 5G communication system is called as a beyond 4G network communication system, a post LTE system, or a new radio (NR) system. In order to achieve a high data transfer rate, 5G communication systems include systems operated using the millimeter wave (mmWave) band of 6 GHz or more, and include a communication system operated using a frequency band of 6 GHz or less in terms of ensuring coverage so that implementations in base stations and terminals are under consideration.

A 3rd generation partnership project (3GPP) NR system enhances spectral efficiency of a network and enables a communication provider to provide more data and voice services over a given bandwidth. Accordingly, the 3GPP NR system is designed to meet the demands for high-speed data and media transmission in addition to supports for large volumes of voice. The advantages of the NR system are to have a higher throughput and a lower latency in an identical platform, support for frequency division duplex (FDD) and time division duplex (TDD), and a low operation cost with an enhanced end-user environment and a simple architecture. For more efficient data processing, dynamic TDD of the NR system may use a method for varying the number of orthogonal frequency division multiplexing (OFDM) symbols that may be used in an uplink and downlink according to data traffic directions of cell users. For example, when the downlink traffic of the cell is larger than the uplink traffic, the base station may allocate a plurality of downlink OFDM symbols to a slot (or subframe). Information about the slot configuration should be transmitted to the terminals.

In order to alleviate the path loss of radio waves and increase the transmission distance of radio waves in the mmWave band, in 5G communication systems, beamforming, massive multiple input/output (massive MIMO), full dimensional MIMO (FD-MIMO), array antenna, analog beam-forming, hybrid beamforming that combines analog beamforming and digital beamforming, and large scale antenna technologies are discussed. In addition, for network improvement of the system, in the 5G communication system, technology developments related to evolved small cells, advanced small cells, cloud radio access network (cloud RAN), ultra-dense network, device to device communication (D2D), vehicle to everything communication (V2X), wireless backhaul, non-terrestrial network communication (NTN), moving network, cooperative communication, coordinated multi-points (CoMP), interference cancellation, and the like are being made. In addition, in the 5G system, hybrid FSK and QAM modulation (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced connectivity technologies, are being developed.

Meanwhile, in a human-centric connection network where humans generate and consume information, the Internet has evolved into the Internet of Things (IoT) network, which exchanges information among distributed components such as objects. Internet of Everything (IoE) technology, which combines IoT technology with big data processing technology through connection with cloud servers, is also emerging. In order to implement IoT, technology elements such as sensing technology, wired/wireless communication and network infrastructure, service interface technology, and security technology are required, so that in recent years, technologies such as sensor network, machine to machine (M2M), and machine type communication (MTC) have been studied for connection between objects. In the IoT environment, an intelligent internet technology (IT) service that collects and analyzes data generated from connected objects to create new value in human life can be provided. Through the fusion and mixture of existing information technology (IT) and various industries, IoT can be applied to fields such as smart home, smart building, smart city, smart car or connected car, smart grid, healthcare, smart home appliance, and advanced medical service.

Accordingly, various attempts have been made to apply the 5G communication system to the IoT network. For example, technologies such as a sensor network, a machine to machine (M2M), and a machine type communication (MTC) are implemented by techniques such as beamforming, MIMO, and array antennas. The application of the cloud RAN as the big data processing technology described above is an example of the fusion of 5G technology and IoT technology. Generally, a mobile communication system has been developed to provide voice service while ensuring the user's activity.

However, the mobile communication system is gradually expanding not only the voice but also the data service, and now it has developed to the extent of providing high-speed data service. However, in a mobile communication system in which services are currently being provided, a more advanced mobile communication system is required due to a shortage phenomenon of resources and a high-speed service demand of users.

### DISCLOSURE OF INVENTION

### Technical Problem

An aspect of this specification is to provide a method for transmitting an uplink channel in a wireless communication system, and an apparatus therefor.

### Solution to Problem

The present specification provides a method for transmitting an uplink channel in a wireless communication system and a device therefor.

Specifically, in a wireless communication system, a UE may include: a transceiver; and a processor configured to control the transceiver, wherein the processor is configured to: receive information about a slot in a time division duplex (TDD) system; receive information about multiple subbands on a frequency domain resource, the multiple subbands being configured on a frequency domain resource within a predetermined time domain resource of the slot, the frequency domain resource being included within a carrier bandwidth of the UE, the information about the slot including information indicating a type of symbol in the slot, and the information about the multiple subbands including information related to a position of at least one of the multiple subbands in a frequency domain and information related to a type of the at least one subband; and perform uplink transmission on a resource within a subband determined as a subband for the uplink transmission based on the information about the multiple subbands.

The UE may receive dynamic signaling that indicates information deactivating the multiple subbands and the type of symbols in the slot. In case that a slot in which a subband deactivated based on the deactivating information is configured is the downlink slot, the type of symbols in the slot may be indicated as a downlink symbol. In case that a slot in which a subband deactivated based on the deactivating information is configured is the flexible slot, the type of symbols in the slot may be indicated as one of a downlink symbol, an uplink symbol, and a flexible symbol. The downlink symbol may be a symbol available for downlink reception, the uplink symbol may be a symbol available for uplink transmission, and the flexible symbol may be a symbol available for the downlink reception or for the uplink transmission.

Furthermore, in the present specification, a method performed by a UE in a wireless communication system may include: receiving information about a slot in a time division duplex (TDD) system; receiving information about multiple subbands on a frequency domain resource, the multiple subbands being configured on a frequency domain resource within a predetermined time domain resource of the slot, the frequency domain resource being included within a carrier bandwidth of the UE, the information about the slot including information indicating a type of symbol in the slot, and the information about the multiple subbands including information related to a position of each of the multiple subbands in a frequency domain and information related to a type of each subband; and performing uplink transmission on a resource within a subband determined as a subband for the uplink transmission based on the information about the multiple subbands.

Furthermore, the method performed by the UE may further include receiving dynamic signaling that includes information for deactivating the multiple subbands and information indicating the type of symbols in the slot. In case that a slot in which a subband deactivated based on the deactivating information is configured is the downlink slot, the type of symbols in the slot may be indicated as a downlink symbol. In case that a slot in which a subband deactivated based on the deactivating information is configured is the flexible slot, the type of symbols in the slot may be indicated as one of a downlink symbol, an uplink symbol, and a flexible symbol. The downlink symbol may be a symbol available for downlink reception, the uplink symbol may be a symbol available for uplink transmission, and the flexible symbol may be a symbol available for the downlink reception or for the uplink transmission.

One subband, among the multiple subbands, may be determined as the subband for the uplink transmission based on the information about the multiple subbands.

The subband determined as the subband for uplink transmission may include a lowest frequency band or a highest frequency band on the frequency domain resource.

In case that the multiple subbands are three or more, the subband determined as the subband for the uplink transmission may be positioned between two or more remaining subbands.

The information about the multiple subbands may include information about an index of the slot, the number of first RBs constituting a first type of subband, and the number of second RBs constituting a second type of subband, wherein the first type of subband may include as many RBs as the number of the first RBs, starting from a first RB in the frequency domain resource of the slot, and the second type of subband may include as many RBs as the number of the second RBs, starting from a last RB in the frequency domain resource of the slot.

The information about the multiple subbands may be applied to a slot that is determined as a downlink slot or a flexible slot based on the information about the slot.

The downlink slot may include a downlink symbol, the flexible slot may include at least one of a downlink symbol, an uplink symbol, and a flexible symbol, the downlink symbol may be a symbol available for downlink reception, the uplink symbol may be a symbol available for uplink transmission, and the flexible symbol may be a symbol available for the downlink reception or for the uplink transmission.

The information about the slot and the information about the multiple subbands may be configured semi-statically. 20

The dynamic signaling may include information instructing the type of symbol in the slot to be configured as a preconfigured type.

Further, in the present specification, in a wireless communication system, a base station may include: a transceiver; and a processor configured to control the transceiver, wherein the processor is configured to: transmit information about a slot in a time division duplex (TDD) system; transmit information about multiple subbands on a frequency domain resource, the multiple subbands being configured on a frequency domain resource within a predetermined time domain resource of the slot, the frequency domain resource being included within a carrier bandwidth of a UE, the information about the slot including information indicating a type of symbol in the slot, and the information about the multiple subbands including information related to a position of at least one of the multiple subbands in a frequency domain and information related to a type of the at least one subband; and perform uplink reception on a resource within a subband determined as a subband for the uplink reception based on the information about the multiple subbands.

Further, in the present specification, in a wireless communication system, a method performed by a base station may include: transmitting information about a slot in a time division duplex (TDD) system; transmitting information about multiple subbands on a frequency domain resource, the multiple subbands being configured on a frequency domain resource within a predetermined time domain resource of the slot, the frequency domain resource being included within a carrier bandwidth of a UE, the information about the slot including information indicating a type of symbol in the slot, and the information about the multiple subbands including information related to a position of at least one of the multiple subbands in a frequency domain and information related to a type of the at least one subband; and performing uplink reception on a resource within a subband determined as a subband for the uplink reception based on the information about the multiple subbands.

### Advantageous Effects of Invention

An aspect of the present specification is to provide a method for configuring a subband.

The effects to be derived from the present specification are not limited to the above-described effects, and other effects that have not been described will be clearly understood by those skilled in the art to which the present disclosure belongs from the following description.

### BRIEF DESCRIPTION OF DRAWINGS

FIG. 1 illustrates an example of a wireless frame structure used in a wireless communication system.

FIG. 2 illustrates an example of a downlink (DL)/uplink (UL) slot structure in a wireless communication system.

FIG. 3 is a diagram for explaining a physical channel used in a 3GPP system and a typical signal transmission method using the physical channel.

FIG. 4a and FIG. 4b illustrates an SS/PBCH block for initial cell access in a 3GPP NR system.

FIG. 5a and FIG. 5b illustrate a procedure for transmitting control information and a control channel in a 3GPP NR system.

FIG. 6 illustrates a control resource set (CORESET) in which a physical downlink control channel (PDCCH) may be transmitted in a 3GPP NR system.

FIG. 7 illustrates a method for configuring a PDCCH search space in a 3GPP NR system.

FIG. 8 is a conceptual diagram illustrating carrier aggregation.

FIG. 9 is a diagram for explaining signal carrier communication and multiple carrier communication.

FIG. 10 is a diagram showing an example in which a cross carrier scheduling technique is applied.

FIG. 11 is a block diagram showing the configurations of a UE and a base station according to an embodiment of the present disclosure.

FIGS. 12 to 18 illustrate a method for configuring a subband according to an embodiment of the present disclosure.

FIGS. 19 and 20 illustrate a method for activating or releasing a subband according to an embodiment of the present disclosure.

FIGS. 21 and 22 illustrate a BWP configuration in a TDD system according to an embodiment of the present disclosure.

FIGS. 23 to 27 illustrate a method for configuring a subband according to an embodiment of the present disclosure.

FIG. 28 illustrates a method for indicating fallback by a dynamic SFI according to an embodiment of the present disclosure.

FIGS. 29 to 33 illustrate symbols in a slot within a subband according to an embodiment of the present.

### BEST MODE FOR CARRYING OUT THE INVENTION

Terms used in the specification adopt general terms which are currently widely used as possible by considering functions in the present disclosure, but the terms may be changed depending on an intention of those skilled in the art, customs, and emergence of new technology. Further, in a specific case, there is a term arbitrarily selected by an applicant and in this case, a meaning thereof will be described in a corresponding description part of the present disclosure. Accordingly, it intends to be revealed that a term used in the specification should be analyzed based on not just a name of the term but a substantial meaning of the term and contents throughout the specification.

Throughout this specification and the claims that follow, when it is described that an element is “connected” to another element, the element may be “directly connected” to the other element or “electrically connected” to the other element through a third element. Further, unless explicitly described to the contrary, the word “comprise” will be understood to imply the inclusion of stated elements but not the exclusion of any other elements unless otherwise stated. Moreover, limitations such as “more than or equal to” or “less than or equal to” based on a specific threshold may be appropriately substituted with “more than” or “less than”, respectively, in some exemplary embodiments.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), and the like. The CDMA may be implemented by a wireless technology such as universal terrestrial radio access (UTRA) or CDMA2000. The TDMA may be implemented by a wireless technology such as global system for mobile communications (GSM)/general packet radio service (GPRS)/enhanced data rates for GSM evolution (EDGE). The OFDMA may be implemented by a wireless technology such as IEEE 802.11 (Wi-Fi), IEEE 802.16 (WiMAX), IEEE 802-20, evolved UTRA (E-UTRA), and the like. The UTRA is a part of a universal mobile telecommunication system (UMTS). 3rd generation partnership project (3GPP) long term evolution (LTE) is a part of an evolved UMTS (E-UMTS) using evolved-UMTS terrestrial radio access (E-UTRA) and LTE-advanced (A) is an evolved version of the 3GPP LTE. 3GPP new radio (NR) is a system designed separately from LTE/LTE-A, and is a system for supporting enhanced mobile broadband (cMBB), ultra-reliable and low latency communication (URLLC), and massive machine type communication (mMTC) services, which are requirements of IMT-2020. For the clear description, 3GPP NR is mainly described, but the technical idea of the present disclosure is not limited thereto.

Unless otherwise specified in this specification, a base station may refer to a next generation node B (gNB) as defined in 3GPP NR. Furthermore, unless otherwise specified, a terminal may refer to a user equipment (UE). Hereinafter, in order to facilitate understanding of the description, each content is separately divided into embodiments and described, but each of the embodiments may be used in combination with each other. In the present disclosure, the configuration of the UE may indicate configuration by the base station. Specifically, the base station may transmit a channel or signal to the UE to configure an operation of the UE or a parameter value used in a wireless communication system.

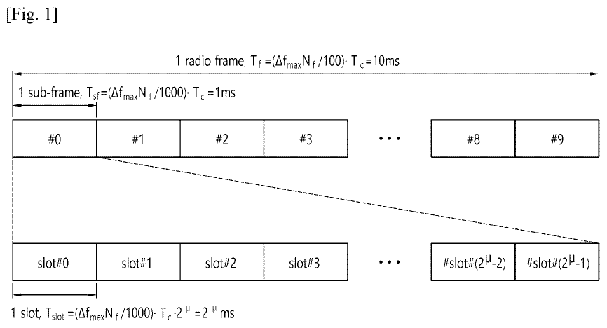

FIG. 1 illustrates an example of a wireless frame structure used in a wireless communication system.

Referring to FIG. 1, the wireless frame (or radio frame) used in the 3GPP NR system may have a length of 10 ms (ΔfₘₐₓN_{f}/100)*T_{c}). In addition, the wireless frame includes 10 subframes (SFs) having equal sizes. Herein, Δfₘₐₓ=480*10³ Hz, N_{f}=4096, T_{c}=1/(Δf_{ref}*N_{f,ref}), Δf_{ref}=15*10³ Hz, and N_{f,ref}=2048. Numbers from 0 to 9 may be respectively allocated to 10 subframes within one subframe. Each subframe has a length of 1 ms and may include one or more slots according to a subcarrier spacing. More specifically, in the 3GPP NR system, the subcarrier spacing that may be used is 15*2^{μ} kHz, and μ can have a value of μ=0, 1, 2, 3, 4 as subcarrier spacing configuration. That is, 15 kHz, 30 kHz, 60 kHz, 120 kHz and 240 kHz may be used for subcarrier spacing. One subframe having a length of 1 ms may include 2^{μ} slots. In this case, the length of each slot is 2^{-μ} ms. Numbers from 0 to 2^{μ}−1 may be respectively allocated to 2^{μ} slots within one wireless frame. In addition, numbers from 0 to 10*2^{μ}−1 may be respectively allocated to slots within one subframe. The time resource may be distinguished by at least one of a wireless frame number (also referred to as a wireless frame index), a subframe number (also referred to as a subframe number), and a slot number (or a slot index).

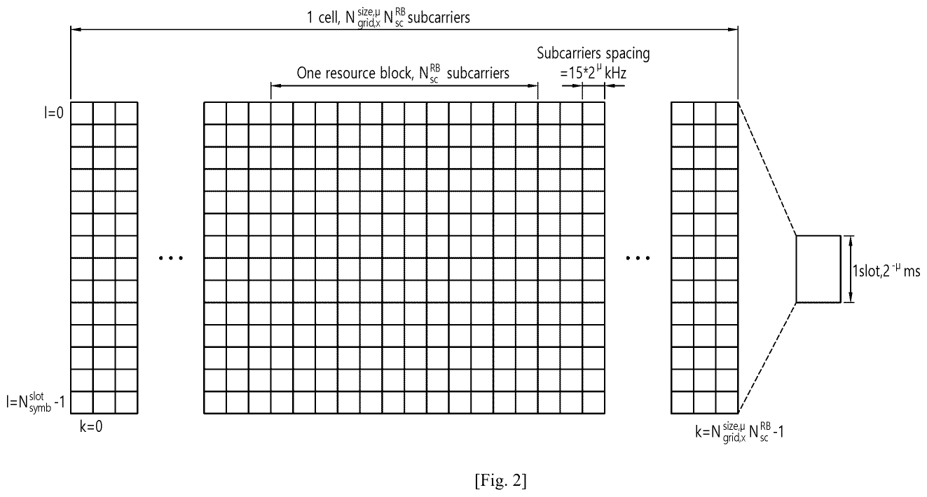

FIG. 2 illustrates an example of a downlink (DL)/uplink (UL) slot structure in a wireless communication system. In particular, FIG. 2 shows the structure of the resource grid of the 3GPP NR system.

There is one resource grid per antenna port. Referring to FIG. 2, a slot includes a plurality of orthogonal frequency division multiplexing (OFDM) symbols in a time domain and includes a plurality of resource blocks (RBs) in a frequency domain. An OFDM symbol also means one symbol section. Unless otherwise specified, OFDM symbols may be referred to simply as symbols. One RB includes 12 consecutive subcarriers in the frequency domain. Referring to FIG. 2, a signal transmitted from each slot may be represented by a resource grid including N^{size,μ}_{grid,x}*N^{RB}_{sc} subcarriers, and N^{slot}_{symb} OFDM symbols. Here, x=DL when the signal is a DL signal, and x=UL when the signal is an UL signal. N^{size,μ}_{grid,x} represents the number of resource blocks (RBs) according to the subcarrier spacing constituent μ (x is DL or UL), and N^{slot}_{symb} represents the number of OFDM symbols in a slot. N^{RB}_{sc} is the number of subcarriers constituting one RB and N^{RB}_{sc}=12. An OFDM symbol may be referred to as a cyclic shift OFDM (CP-OFDM) symbol or a discrete Fourier transform spread OFDM (DFT-s-OFDM) symbol according to a multiple access scheme.

The number of OFDM symbols included in one slot may vary according to the length of a cyclic prefix (CP). For example, in the case of a normal CP, one slot includes 14 OFDM symbols, but in the case of an extended CP, one slot may include 12 OFDM symbols. In a specific embodiment, the extended CP can only be used at 60 kHz subcarrier spacing. In FIG. 2, for convenience of description, one slot is configured with 14 OFDM symbols by way of example, but embodiments of the present disclosure may be applied in a similar manner to a slot having a different number of OFDM symbols. Referring to FIG. 2, each OFDM symbol includes N^{size,μ}_{grid,x}*N^{RB}_{sc} subcarriers in the frequency domain. The type of subcarrier may be divided into a data subcarrier for data transmission, a reference signal subcarrier for transmission of a reference signal, and a guard band. The carrier frequency is also referred to as the center frequency (fc).

One RB may be defined by N^{RB}_{sc} (e. g., 12) consecutive subcarriers in the frequency domain. For reference, a resource configured with one OFDM symbol and one subcarrier may be referred to as a resource element (RE) or a tone. Therefore, one RB can be configured with N^{slot}_{symb}*N^{RB}_{sc} resource elements. Each resource element in the resource grid can be uniquely defined by a pair of indexes (k, l) in one slot. k may be an index assigned from 0 to N^{size,μ}_{grid,x}*N^{RB}_{sc}−1 in the frequency domain, and l may be an index assigned from 0 to N^{slot}_{symb}−1 in the time domain.

In order for the UE to receive a signal from the base station or to transmit a signal to the base station, the time/frequency of the UE may be synchronized with the time/frequency of the base station. This is because when the base station and the UE are synchronized, the UE can determine the time and frequency parameters necessary for demodulating the DL signal and transmitting the UL signal at the correct time.

Each symbol of a radio frame used in a time division duplex (TDD) or an unpaired spectrum may be configured with at least one of a DL symbol, an UL symbol, and a flexible symbol. A radio frame used as a DL carrier in a frequency division duplex (FDD) or a paired spectrum may be configured with a DL symbol or a flexible symbol, and a radio frame used as a UL carrier may be configured with a UL symbol or a flexible symbol. In the DL symbol, DL transmission is possible, but UL transmission is impossible. In the UL symbol, UL transmission is possible, but DL transmission is impossible. The flexible symbol may be determined to be used as a DL or an UL according to a signal.

Information on the type of each symbol, i.e., information representing any one of DL symbols, UL symbols, and flexible symbols, may be configured with a cell-specific or common radio resource control (RRC) signal. In addition, information on the type of each symbol may additionally be configured with a UE-specific or dedicated RRC signal. The base station informs, by using cell-specific RRC signals, i) the period of cell-specific slot configuration, ii) the number of slots with only DL symbols from the beginning of the period of cell-specific slot configuration, iii) the number of DL symbols from the first symbol of the slot immediately following the slot with only DL symbols, iv) the number of slots with only UL symbols from the end of the period of cell specific slot configuration, and v) the number of UL symbols from the last symbol of the slot immediately before the slot with only the UL symbol. Here, symbols not configured with any one of a UL symbol and a DL symbol are flexible symbols.

When the information on the symbol type is configured with the UE-specific RRC signal, the base station may signal whether the flexible symbol is a DL symbol or an UL symbol in the cell-specific RRC signal. In this case, the UE-specific RRC signal can not change a DL symbol or a UL symbol configured with the cell-specific RRC signal into another symbol type. The UE-specific RRC signal may signal the number of DL symbols among the N^{slot}_{symb} symbols of the corresponding slot for each slot, and the number of UL symbols among the N^{slot}_{symb} symbols of the corresponding slot. In this case, the DL symbol of the slot may be continuously configured with the first symbol to the i-th symbol of the slot. In addition, the UL symbol of the slot may be continuously configured with the j-th symbol to the last symbol of the slot (where i<j). In the slot, symbols not configured with any one of a UL symbol and a DL symbol are flexible symbols.

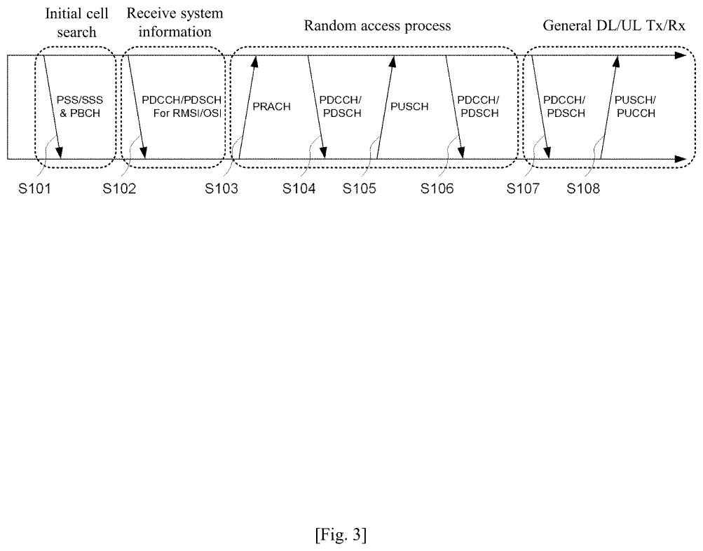

FIG. 3 is a diagram for explaining a physical channel used in a 3GPP system (e.g., NR) and a typical signal transmission method using the physical channel.

If the power of the UE is turned on or the UE camps on a new cell, the UE performs an initial cell search (S101). Specifically, the UE may synchronize with the BS in the initial cell search. For this, the UE may receive a primary synchronization signal (PSS) and a secondary synchronization signal (SSS) from the base station to synchronize with the base station, and obtain information such as a cell ID. Thereafter, the UE can receive the physical broadcast channel from the base station and obtain the broadcast information in the cell.

Upon completion of the initial cell search, the UE receives a physical downlink shared channel (PDSCH) according to the physical downlink control channel (PDCCH) and information in the PDCCH, so that the UE can obtain more specific system information than the system information obtained through the initial cell search (S102). Here, the system information received by the UE is cell-common system information for the UE to properly operate at the physical layer in Radio Resource Control (RRC), and is referred to as remaining system information (RSMI) or system information block (SIB) 1.

When the UE initially accesses the base station or does not have radio resources for signal transmission (when the UE is in RRC_IDLE mode), the UE may perform a random access procedure on the base station (operations S103 to S106). First, the UE may transmit a preamble through a physical random access channel (PRACH) (S103), and eceive a response message for the preamble from the base station through the PDCCH and the corresponding PDSCH (S104). When a valid random access response is received by the UE, the UE transmits data including the identifier of the UE and the like to the base station through a physical uplink shared channel (PUSCH) indicated by the UL grant transmitted through the PDCCH from the base station (S105). Next, the UE waits for reception of the PDCCH as an indication of the base station for collision resolution. If the UE successfully receives the PDCCH through the identifier of the UE (S106), the random access process is terminated. During the random access process, the UE may obtain UE-specific system information necessary for the UE to properly operate at the physical layer in the RRC layer. When the UE obtains UE-specific system information from the RRC layer, the UE enters the RRC_CONNECTED mode.

The RRC layer is used for message generation and management for control between a UE and a radio access network (RAN). More specifically, in the RRC layer, the base station and the UE may perform broadcasting of cell system information, delivery management of paging messages, mobility management and handover, measurement report and control thereof, UE capability management, and storage management including existing management necessary for all UEs in the cell. In general, since the update of the signal (hereinafter, referred to as RRC signal) transmitted from the RRC layer is longer than the transmission/reception period (i.e., transmission time interval, TTI) in the physical layer, the RRC signal may be maintained unchanged for a long period.

After the above-described procedure, the UE receives PDCCH/PDSCH (S107) and transmits a physical uplink shared channel (PUSCH)/physical uplink control channel (PUCCH) (S108) as a general UL/DL signal transmission procedure. In particular, the UE may receive downlink control information (DCI) through the PDCCH. The DCI may include control information such as resource allocation information for the UE. Also, the format of the DCI may vary depending on the intended use. The uplink control information (UCI) that the UE transmits to the base station through UL includes a DL/UL ACK/NACK signal, a channel quality indicator (CQI), a precoding matrix index (PMI), a rank indicator (RI), and the like. Here, the CQI, PMI, and RI may be included in channel state information (CSI). In the 3GPP NR system, the UE may transmit control information such as HARQ-ACK and CSI described above through the PUSCH and/or PUCCH.

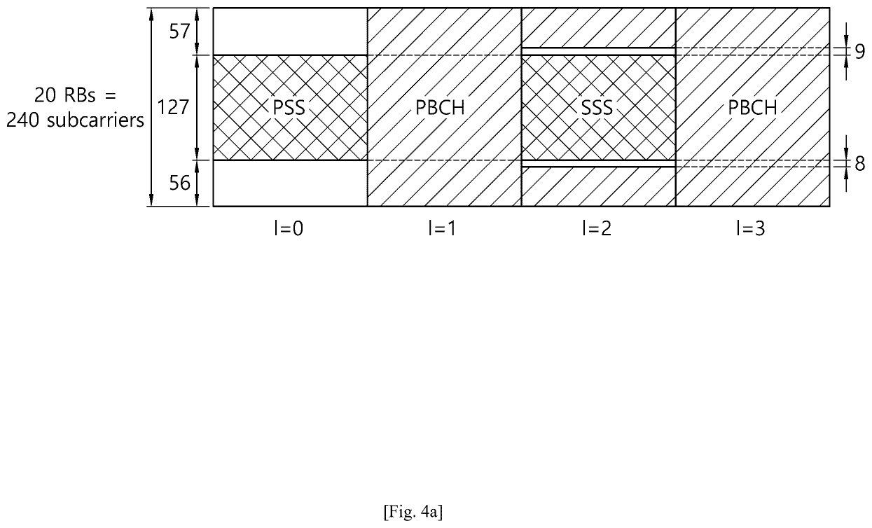

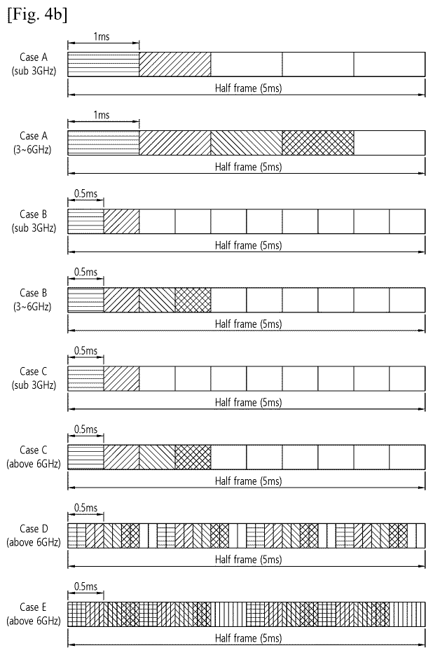

FIGS. 4a and 4b illustrate an SS/PBCH block for initial cell access in a 3GPP NR system.

When the power is turned on or wanting to access a new cell, the UE may obtain time and frequency synchronization with the cell and perform an initial cell search procedure. The UE may detect a physical cell identity NcellID of the cell during a cell search procedure. For this, the UE may receive a synchronization signal, for example, a primary synchronization signal (PSS) and a secondary synchronization signal (SSS), from a base station, and synchronize with the base station. In this case, the UE can obtain information such as a cell identity (ID).

Referring to FIG. 4a, a synchronization signal (SS) will be described in more detail. The synchronization signal can be classified into PSS and SSS. The PSS may be used to obtain time domain synchronization and/or frequency domain synchronization, such as OFDM symbol synchronization and slot synchronization. The SSS can be used to obtain frame synchronization and cell group ID. Referring to FIG. 4a and Table 1, the SS/PBCH block can be configured with consecutive 20 RBs (=240 subcarriers) in the frequency axis, and can be configured with consecutive 4 OFDM symbols in the time axis. In this case, in the SS/PBCH block, the PSS is transmitted in the first OFDM symbol and the SSS is transmitted in the third OFDM symbol through the 56th to 182th subcarriers. Here, the lowest subcarrier index of the SS/PBCH block is numbered from 0. In the first OFDM symbol in which the PSS is transmitted, the base station does not transmit a signal through the remaining subcarriers, i.e., 0th to 55th and 183th to 239th subcarriers. In addition, in the third OFDM symbol in which the SSS is transmitted, the base station does not transmit a signal through 48th to 55th and 183th to 191th subcarriers. The base station transmits a physical broadcast channel (PBCH) through the remaining RE except for the above signal in the SS/PBCH block.

TABLE 1

| | OFDM symbol number/ | Subcarrier number k |
|---|---|---|
| Channel | relative to the start | relative to the start |
| or signal | of an SS/PBCH block | of an SS/PBCH block |
| PSS | 0 | 56, 57, . . . , 182 |
| SSS | 2 | 56, 57, . . . , 182 |
| Set to 0 | 0 | 0, 1, . . . , 55, 183, 184, |
| | | . . . , 239 |
| | 2 | 48, 49, . . . , 55, 183, 184, |
| | | . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + v, 4 + v, 8 + v, |
| PBCH | | . . . , 236 + v |
| | 2 | 0 + v, 4 + v, 8 + v, |
| | | . . . , 44 + v |
| | | 192 + v, 196 + v, |
| | | . . . , 236 + v |

The SS allows a total of 1008 unique physical layer cell IDs to be grouped into 336 physical-layer cell-identifier groups, each group including three unique identifiers, through a combination of three PSSs and SSSs, specifically, such that each physical layer cell ID is to be only a part of one physical-layer cell-identifier group. Therefore, the physical layer cell ID N^{cell}_{ID}=3N⁽¹⁾_{ID}+N⁽²⁾_{ID} can be uniquely defined by the index N⁽¹⁾_{ID} ranging from 0 to 335 indicating a physical-layer cell-identifier group and the index N⁽²⁾_{ID} ranging from 0 to 2 indicating a physical-layer identifier in the physical-layer cell-identifier group. The UE may detect the PSS and identify one of the three unique physical-layer identifiers. In addition, the UE can detect the SSS and identify one of the 336 physical layer cell IDs associated with the physical-layer identifier. In this case, the sequence d_{PSS}(n) of the PSS is as follows.

$${d}_{PSS} ( n ) = 1 - 2 x ( m )$$

$$m = ( n + 43 {N}_{ID}^{( 2 )} ) mod 127$$

$$0 \leq n < 127$$

Here, x(i+7)=(x(i+4)+x(i)mod 2 and is given as,

$$[ \begin{matrix}x ( 6 ) & x ( 5 ) & x ( 4 ) & x ( 3 ) & x ( 2 ) & x ( 1 ) & x ( 0 ) ] = [ \begin{matrix}1 & 1 & 1 & 0 & 1 & 1 & 0\end{matrix} ]\end{matrix}$$

Further, the sequence d_{SSS}(n) of the SSS is as follows.

$${d}_{SSS} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

Here,

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2$$

and is given as,

$$[ \begin{matrix}{x}_{0} ( 6 ) & {x}_{0} ( 5 ) & {x}_{0} ( 4 ) & {x}_{0} ( 3 ) & {x}_{0} ( 2 ) & {x}_{0} ( 1 ) & {x}_{0} ( 0 ) ] = [ \begin{matrix}0 & 0 & 0 & 0 & 0 & 0 & 1\end{matrix} ]\end{matrix}$$

$$[ \begin{matrix}{x}_{1} ( 6 ) & {x}_{1} ( 5 ) & {x}_{1} ( 4 ) & {x}_{1} ( 3 ) & {x}_{1} ( 2 ) & {x}_{1} ( 1 ) & {x}_{1} ( 0 ) ] = [ \begin{matrix}0 & 0 & 0 & 0 & 0 & 0 & 1\end{matrix} ]\end{matrix}$$

A radio frame with a 10 ms length may be divided into two half frames with a 5 ms length. Referring to FIG. 4b, a description will be made of a slot in which SS/PBCH blocks are transmitted in each half frame. A slot in which the SS/PBCH block is transmitted may be any one of the cases A, B, C, D, and E. In the case A, the subcarrier spacing is 15 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case B, the subcarrier spacing is 30 kHz and the starting time point of the SS/PBCH block is {4, 8, 16, 20}+28*n. In this case, n=0 at a carrier frequency of 3 GHz or less. In addition, it may be n=0, 1 at carrier frequencies above 3 GHZ and below 6 GHz. In the case C, the subcarrier spacing is 30 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case D, the subcarrier spacing is 120 kHz and the starting time point of the SS/PBCH block is the ({4, 8, 16, 20}+28*n)-th symbol. In this case, at a carrier frequency of 6 GHz or more, n=0, 1, 2, 3, 5, 6, 7, 8, 10, 11, 12, 13, 15, 16, 17, 18. In the case E, the subcarrier spacing is 240 kHz and the starting time point of the SS/PBCH block is the ({8, 12, 16, 20, 32, 36, 40, 44}+56*n)-th symbol. In this case, at a carrier frequency of 6 GHz or more, n=0, 1, 2, 3, 5, 6, 7, 8.

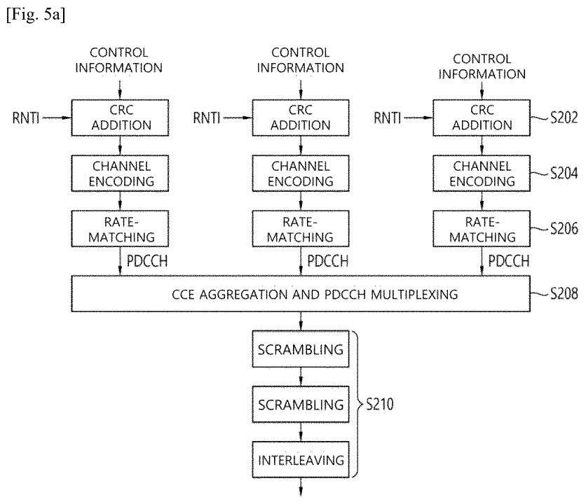

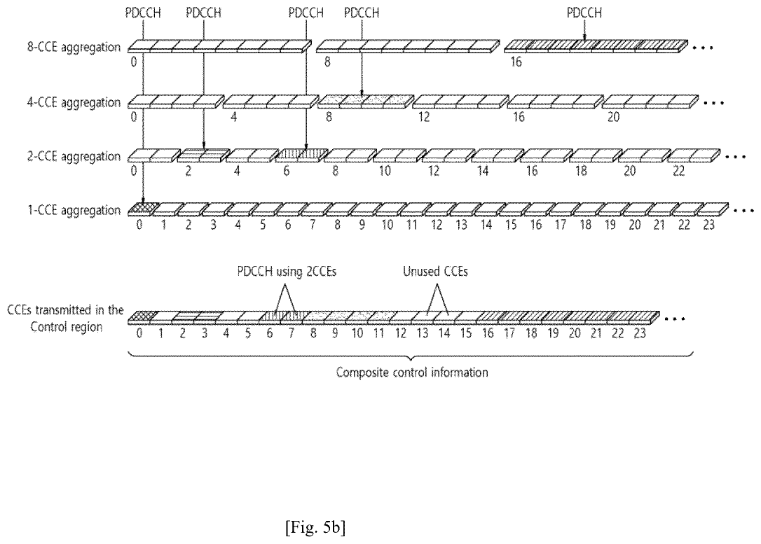

FIGS. 5a and 5b illustrate a procedure for transmitting control information and a control channel in a 3GPP NR system. Referring to FIG. 5a, the base station may add a cyclic redundancy check (CRC) masked (e.g., an XOR operation) with a radio network temporary identifier (RNTI) to control information (e.g., downlink control information (DCI)) (S202). The base station may scramble the CRC with an RNTI value determined according to the purpose/target of each control information. The common RNTI used by one or more UEs can include at least one of a system information RNTI (SI-RNTI), a paging RNTI (P-RNTI), a random access RNTI (RA-RNTI), and a transmit power control RNTI (TPC-RNTI). In addition, the UE-specific RNTI may include at least one of a cell temporary RNTI (C-RNTI), and the CS-RNTI. Thereafter, the base station may perform rate-matching (S206) according to the amount of resource(s) used for PDCCH transmission after performing channel encoding (e.g., polar coding) (S204). Thereafter, the base station may multiplex the DCI(s) based on the control channel element (CCE) based PDCCH structure (S208). In addition, the base station may apply an additional process (S210) such as scrambling, modulation (e.g., QPSK), interleaving, and the like to the multiplexed DCI(s), and then map the DCI(s) to the resource to be transmitted. The CCE is a basic resource unit for the PDCCH, and one CCE may include a plurality (e.g., six) of resource element groups (REGs). One REG may be configured with a plurality (e.g., 12) of REs. The number of CCEs used for one PDCCH may be defined as an aggregation level. In the 3GPP NR system, an aggregation level of 1, 2, 4, 8, or 16 may be used. FIG. 5b is a diagram related to a CCE aggregation level and the multiplexing of a PDCCH and illustrates the type of a CCE aggregation level used for one PDCCH and CCE(s) transmitted in the control area according thereto.

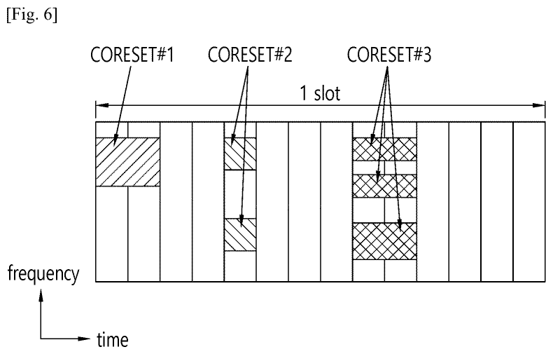

FIG. 6 illustrates a control resource set (CORESET) in which a physical downlink control channel (PDCCH) may be transmitted in a 3GPP NR system.

The CORESET is a time-frequency resource in which PDCCH, that is, a control signal for the UE, is transmitted. In addition, a search space to be described later may be mapped to one CORESET. Therefore, the UE may monitor the time-frequency domain designated as CORESET instead of monitoring all frequency bands for PDCCH reception, and decode the PDCCH mapped to CORESET. The base station may configure one or more CORESETs for each cell to the UE. The CORESET may be configured with up to three consecutive symbols on the time axis. In addition, the CORESET may be configured in units of six consecutive PRBs on the frequency axis. In the embodiment of FIG. 6, CORESET #1 is configured with consecutive PRBs, and CORESET #2 and CORESET #3 are configured with discontinuous PRBs. The CORESET can be located in any symbol in the slot. For example, in the embodiment of FIG. 5, CORESET #1 starts at the first symbol of the slot, CORESET #2 starts at the fifth symbol of the slot, and CORESET #9 starts at the ninth symbol of the slot.

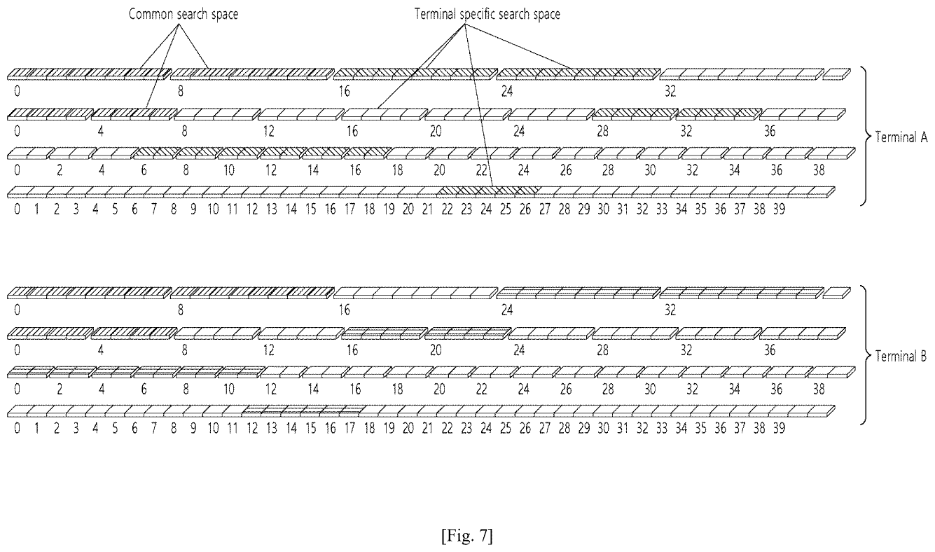

FIG. 7 illustrates a method for setting a PDCCH search space in a 3GPP NR system.

In order to transmit the PDCCH to the UE, each CORESET may have at least one search space. In the embodiment of the present disclosure, the search space is a set of all time-frequency resources (hereinafter, PDCCH candidates) through which the PDCCH of the UE is capable of being transmitted. The search space may include a common search space that the UE of the 3GPP NR is required to commonly search and a Terminal-specific or a UE-specific search space that a specific UE is required to search. In the common search space, UE may monitor the PDCCH that is set so that all UEs in the cell belonging to the same base station commonly search. In addition, the UE-specific search space may be set for each UE so that UEs monitor the PDCCH allocated to each UE at different search space position according to the UE. In the case of the UE-specific search space, the search space between the UEs may be partially overlapped and allocated due to the limited control area in which the PDCCH may be allocated. Monitoring the PDCCH includes blind decoding for PDCCH candidates in the search space. When the blind decoding is successful, it may be expressed that the PDCCH is (successfully) detected/received and when the blind decoding fails, it may be expressed that the PDCCH is not detected/not received, or is not successfully detected/received.

For convenience of explanation, a PDCCH scrambled with a group common (GC) RNTI previously known to UEs so as to transmit DL control information to the one or more UEs is referred to as a group common (GC) PDCCH or a common PDCCH. In addition, a PDCCH scrambled with a specific-terminal RNTI that a specific UE already knows so as to transmit UL scheduling information or DL scheduling information to the specific UE is referred to as a specific-UE PDCCH. The common PDCCH may be included in a common search space, and the UE-specific PDCCH may be included in a common search space or a UE-specific PDCCH.

The base station may signal each UE or UE group through a PDCCH about information (i.e., DL Grant) related to resource allocation of a paging channel (PCH) and a downlink-shared channel (DL-SCH) that are a transmission channel or information (i.e., UL grant) related to resource allocation of a uplink-shared channel (UL-SCH) and a hybrid automatic repeat request (HARQ). The base station may transmit the PCH transport block and the DL-SCH transport block through the PDSCH. The base station may transmit data excluding specific control information or specific service data through the PDSCH. In addition, the UE may receive data excluding specific control information or specific service data through the PDSCH.

The base station may include, in the PDCCH, information on to which UE (one or a plurality of UEs) PDSCH data is transmitted and how the PDSCH data is to be received and decoded by the corresponding UE, and transmit the PDCCH. For example, it is assumed that the DCI transmitted on a specific PDCCH is CRC masked with an RNTI of “A”, and the DCI indicates that PDSCH is allocated to a radio resource (e.g., frequency location) of “B” and indicates transmission format information (e.g., transport block size, modulation scheme, coding information, etc.) of “C”. The UE monitors the PDCCH using the RNTI information that the UE has. In this case, if there is a UE which performs blind decoding the PDCCH using the “A” RNTI, the UE receives the PDCCH, and receives the PDSCH indicated by “B” and “C” through the received PDCCH information.

Table 2 shows an embodiment of a physical uplink control channel (PUCCH) used in a wireless communication system.

TABLE 2

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

PUCCH may be used to transmit the following UL control information (UCI).
Scheduling Request (SR): Information used for requesting a UL UL-SCH resource.
HARQ-ACK: A Response to PDCCH (indicating DL SPS release) and/or a response to DL transport block (TB) on PDSCH. HARQ-ACK indicates whether information transmitted on the PDCCH or PDSCH is received. The HARQ-ACK response includes positive ACK (simply ACK), negative ACK (hereinafter NACK), Discontinuous Transmission (DTX), or NACK/DTX. Here, the term HARQ-ACK is used mixed with HARQ-ACK/NACK and ACK/NACK. In general, ACK may be represented by bit value 1 and NACK may be represented by bit value 0.
Channel State Information (CSI): Feedback information on the DL channel. The UE generates it based on the CSI-Reference Signal (RS) transmitted by the base station. Multiple Input Multiple Output (MIMO)-related feedback information includes a Rank Indicator (RI) and a Precoding Matrix Indicator (PMI). CSI can be divided into CSI part 1 and CSI part 2 according to the information indicated by CSI.

In the 3GPP NR system, five PUCCH formats may be used to support various service scenarios, various channel environments, and frame structures.

PUCCH format 0 is a format capable of transmitting 1-bit or 2-bit HARQ-ACK information or SR. PUCCH format 0 can be transmitted through one or two OFDM symbols on the time axis and one PRB on the frequency axis. When PUCCH format 0 is transmitted in two OFDM symbols, the same sequence to the two symbols may be transmitted through different RBs. In this case, the sequence may be a cyclic shift (CS) sequence from the base sequence used for PUCCH format 0. Through this, the UE can obtain a frequency diversity gain. Specifically, the UE may determine a cyclic shift (CS) value mₑₛ according to the Mbit bit UCI (M_{bit}=1 or 2). In addition, a sequence in which a base sequence of length 12 is cyclically shifted based on a predetermined CS value mₑₛ may be mapped to 1 OFDM symbol and 12 REs of 1 RB and transmitted. When the number of cyclic shifts available to the UE is 12 and M_{bit}=1, 1 bit UCI 0 and 1 may be mapped to two cyclic shifted sequences having a difference of 6 cyclic shift values, respectively. In addition, when M_{bit}=2, 2bits UCI 00, 01, 11, and 10 may be mapped to four cyclic shifted sequences in which the difference in cyclic shift values is 3, respectively.

PUCCH format 1 may deliver 1-bit or 2-bit HARQ-ACK information or SR. PUCCH format 1 may be transmitted through consecutive OFDM symbols on the time axis and one PRB on the frequency axis. Here, the number of OFDM symbols occupied by PUCCH format 1 may be one of 4 to 14. More specifically, UCI, which is M_{bit}=1, may be BPSK-modulated. The UE may modulate UCI, which is M_{bit}=2, with quadrature phase shift keying (QPSK). A signal is obtained by multiplying a modulated complex valued symbol d(0) by a sequence of length 12. In this case, the sequence may be a base sequence used for PUCCH format 0. The UE spreads the even-numbered OFDM symbols to which PUCCH format 1 is allocated through the time axis orthogonal cover code (OCC) to transmit the obtained signal. PUCCH format 1 determines the maximum number of different UEs multiplexed in the one RB according to the length of the OCC to be used. A demodulation reference signal (DMRS) may be spread with OCC and mapped to the odd-numbered OFDM symbols of PUCCH format 1.

PUCCH format 2 may deliver UCI exceeding 2 bits. PUCCH format 2 may be transmitted through one or two OFDM symbols on the time axis and one or a plurality of RBs on the frequency axis. When PUCCH format 2 is transmitted in two OFDM symbols, the sequences which are transmitted in different RBs through the two OFDM symbols may be same each other. Here, the sequence may be a plurality of modulated complex valued symbols d(0), . . . , d(M_{symbol}−1). Here, M_{symbol} may be M_{bit}/2. Through this, the UE may obtain a frequency diversity gain. More specifically, M_{bit} bit UCI (M_{bit}>2) is bit-level scrambled, QPSK modulated, and mapped to RB(s) of one or two OFDM symbol(s). Here, the number of RBs may be one of 1 to 16.

PUCCH format 3 or PUCCH format 4 may deliver UCI exceeding 2 bits. PUCCH format 3 or PUCCH format 4 may be transmitted through consecutive OFDM symbols on the time axis and one PRB on the frequency axis. The number of OFDM symbols occupied by PUCCH format 3 or PUCCH format 4 may be one of 4 to 14. Specifically, the UE modulates M_{bit} bits UCI (M_{bit}>2) with π/2-Binary Phase Shift Keying (BPSK) or QPSK to generate a complex valued symbol d(0) to d(M_{symb}−1). Here, when using π/2-BPSK, M_{symb}=M_{bit}, and when using QPSK, M_{symb}=M_{bit}/2. The UE may not apply block-unit spreading to the PUCCH format 3. However, the UE may apply block-unit spreading to one RB (i.e., 12 subcarriers) using PreDFT-OCC of a length of 12 such that PUCCH format 4 may have two or four multiplexing capacities. The UE performs transmit precoding (or DFT-precoding) on the spread signal and maps it to each RE to transmit the spread signal.

In this case, the number of RBs occupied by PUCCH format 2, PUCCH format 3, or PUCCH format 4 may be determined according to the length and maximum code rate of the UCI transmitted by the UE. When the UE uses PUCCH format 2, the UE may transmit HARQ-ACK information and CSI information together through the PUCCH. When the number of RBs that the UE may transmit is greater than the maximum number of RBs that PUCCH format 2, or PUCCH format 3, or PUCCH format 4 may use, the UE may transmit only the remaining UCI information without transmitting some UCI information according to the priority of the UCI information.

PUCCH format 1, PUCCH format 3, or PUCCH format 4 may be configured through the RRC signal to indicate frequency hopping in a slot. When frequency hopping is configured, the index of the RB to be frequency hopped may be configured with an RRC signal. When PUCCH format 1, PUCCH format 3, or PUCCH format 4 is transmitted through N OFDM symbols on the time axis, the first hop may have floor (N/2) OFDM symbols and the second hop may have ceiling (N/2) OFDM symbols.

PUCCH format 1, PUCCH format 3, or PUCCH format 4 may be configured to be repeatedly transmitted in a plurality of slots. In this case, the number K of slots in which the PUCCH is repeatedly transmitted may be configured by the RRC signal. The repeatedly transmitted PUCCHs must start at an OFDM symbol of the constant position in each slot, and have the constant length. When one OFDM symbol among OFDM symbols of a slot in which a UE should transmit a PUCCH is indicated as a DL symbol by an RRC signal, the UE may not transmit the PUCCH in a corresponding slot and delay the transmission of the PUCCH to the next slot to transmit the PUCCH.

Meanwhile, in the 3GPP NR system, the UE may perform transmission/reception using a bandwidth less than or equal to the bandwidth of the carrier (or cell). To this end, the UE may be configured with a bandwidth part (BWP) consisting of a continuous bandwidth of a portion of the bandwidth of the carrier. A UE operating according to TDD or operating in an unpaired spectrum may receive up to four DL/UL BWP pairs for one carrier (or cell). In addition, the UE may activate one DL/UL BWP pair. A UE operating according to FDD or operating in a paired spectrum may receive up to 4 DL BWPs on a downlink carrier (or cell) and up to 4 UL BWPs on an uplink carrier (or cell). The UE may activate one DL BWP and UL BWP for each carrier (or cell). The UE may not receive or transmit in time-frequency resources other than the activated BWP. The activated BWP may be referred to as an active BWP.

The base station may indicate an activated BWP among the BWPs configured by the UE through downlink control information (DCI). The BWP indicated through DCI is activated, and other configured BWP(s) are deactivated. In a carrier (or cell) operating in TDD, the base station may include a bandwidth part indicator (BPI) indicating the BWP activated in the DCI scheduling the PDSCH or PUSCH to change the DL/UL BWP pair of the UE. The UE may receive a DCI scheduling a PDSCH or a PUSCH and may identify a DL/UL BWP pair activated based on the BPI. In the case of a downlink carrier (or cell) operating in FDD, the base station may include a BPI indicating the activated BWP in the DCI scheduling the PDSCH to change the DL BWP of the UE. In the case of an uplink carrier (or cell) operating in FDD, the base station may include a BPI indicating the activated BWP in the DCI scheduling the PUSCH to change the UL BWP of the UE.

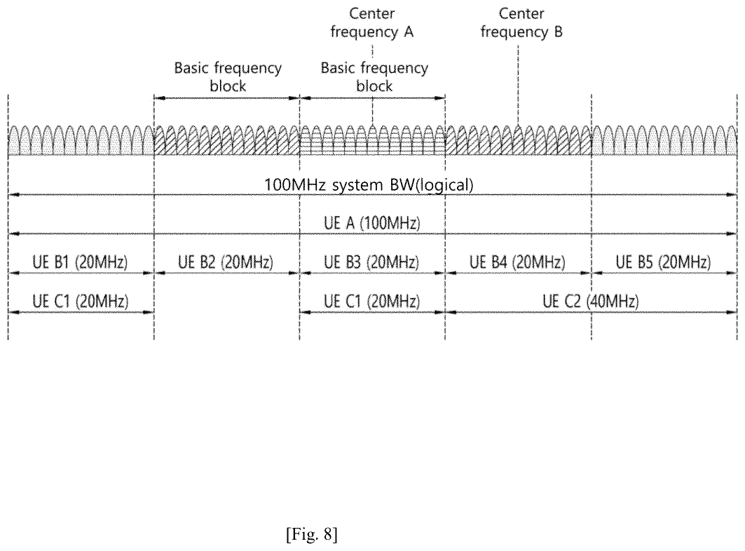

FIG. 8 is a conceptual diagram illustrating carrier aggregation.

The carrier aggregation is a method in which the UE uses a plurality of frequency blocks or cells (in the logical sense) configured with UL resources (or component carriers) and/or DL resources (or component carriers) as one large logical frequency band in order for a wireless communication system to use a wider frequency band. One component carrier may also be referred to as a term called a Primary cell (PCell) or a Secondary cell (SCell), or a Primary SCell (PScell). However, hereinafter, for convenience of description, the term “component carrier” is used.

Referring to FIG. 8, as an example of a 3GPP NR system, the entire system band may include up to 16 component carriers, and each component carrier may have a bandwidth of up to 400 MHz. The component carrier may include one or more physically consecutive subcarriers. Although it is shown in FIG. 8 that each of the component carriers has the same bandwidth, this is merely an example, and each component carrier may have a different bandwidth. Also, although each component carrier is shown as being adjacent to each other in the frequency axis, the drawings are shown in a logical concept, and each component carrier may be physically adjacent to one another, or may be spaced apart.

Different center frequencies may be used for each component carrier. Also, one common center frequency may be used in physically adjacent component carriers. Assuming that all the component carriers are physically adjacent in the embodiment of FIG. 8, center frequency A may be used in all the component carriers. Further, assuming that the respective component carriers are not physically adjacent to each other, center frequency A and the center frequency B can be used in each of the component carriers.

When the total system band is extended by carrier aggregation, the frequency band used for communication with each UE can be defined in units of a component carrier. UE A may use 100 MHz, which is the total system band, and performs communication using all five component carriers. UEs B₁˜B₅ can use only a 20 MHz bandwidth and perform communication using one component carrier. UEs C₁ and C₂ may use a 40 MHz bandwidth and perform communication using two component carriers, respectively. The two component carriers may be logically/physically adjacent or non-adjacent. UE C₁ represents the case of using two non-adjacent component carriers, and UE C₂ represents the case of using two adjacent component carriers.

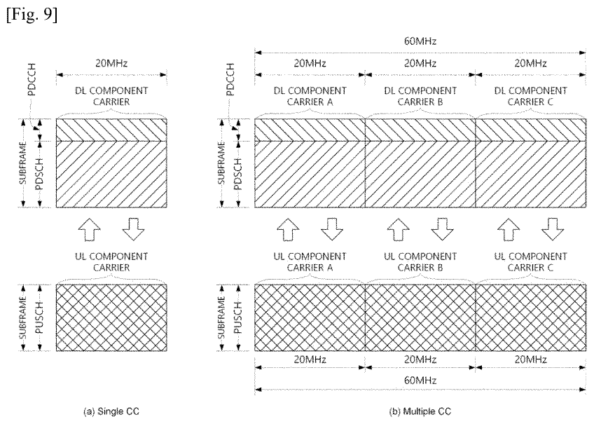

FIG. 9 is a drawing for explaining signal carrier communication and multiple carrier communication. Particularly, FIG. 9(a) shows a single carrier subframe structure and FIG. 9(b) shows a multi-carrier subframe structure.

Referring to FIG. 9(a), in an FDD mode, a general wireless communication system may perform data transmission or reception through one DL band and one UL band corresponding thereto. In another specific embodiment, in a TDD mode, the wireless communication system may divide a radio frame into a UL time unit and a DL time unit in a time domain, and perform data transmission or reception through a UL/DL time unit. Referring to FIG. 9(b), three 20 MHz component carriers (CCs) can be aggregated into each of UL and DL, so that a bandwidth of 60 MHz can be supported. Each CC may be adjacent or non-adjacent to one another in the frequency domain. FIG. 9(b) shows a case where the bandwidth of the UL CC and the bandwidth of the DL CC are the same and symmetric, but the bandwidth of each CC can be determined independently. In addition, asymmetric carrier aggregation with different number of UL CCs and DL CCs is possible. A DL/UL CC allocated/configured to a specific UE through RRC may be called as a serving DL/UL CC of the specific UE.

The base station may perform communication with the UE by activating some or all of the serving CCs of the UE or deactivating some CCs. The base station can change the CC to be activated/deactivated, and change the number of CCs to be activated/deactivated. If the base station allocates a CC available for the UE as to be cell-specific or UE-specific, at least one of the allocated CCs can be deactivated, unless the CC allocation for the UE is completely reconfigured or the UE is handed over. One CC that is not deactivated by the UE is called as a Primary CC (PCC) or a primary cell (PCell), and a CC that the base station can freely activate/deactivate is called as a Secondary CC (SCC) or a secondary cell (SCell).

Meanwhile, 3GPP NR uses the concept of a cell to manage radio resources. A cell is defined as a combination of DL resources and UL resources, that is, a combination of DL CC and UL CC. A cell may be configured with DL resources alone, or a combination of DL resources and UL resources. When the carrier aggregation is supported, the linkage between the carrier frequency of the DL resource (or DL CC) and the carrier frequency of the UL resource (or UL CC) may be indicated by system information. The carrier frequency refers to the center frequency of each cell or CC. A cell corresponding to the PCC is referred to as a PCell, and a cell corresponding to the SCC is referred to as an SCell. The carrier corresponding to the PCell in the DL is the DL PCC, and the carrier corresponding to the PCell in the UL is the UL PCC. Similarly, the carrier corresponding to the SCell in the DL is the DL SCC and the carrier corresponding to the SCell in the UL is the UL SCC. According to UE capability, the serving cell(s) may be configured with one PCell and zero or more SCells. In the case of UEs that are in the RRC_CONNECTED state but not configured for carrier aggregation or that do not support carrier aggregation, there is only one serving cell configured only with PCell.

As mentioned above, the term “cell” used in carrier aggregation is distinguished from the term “cell” which refers to a certain geographical area in which a communication service is provided by one base station or one antenna group. That is, one component carrier may also be referred to as a scheduling cell, a scheduled cell, a primary cell (PCell), a secondary cell (SCell), or a primary SCell (PScell). However, in order to distinguish between a cell referring to a certain geographical area and a cell of carrier aggregation, in the present disclosure, a cell of a carrier aggregation is referred to as a CC, and a cell of a geographical area is referred to as a cell.

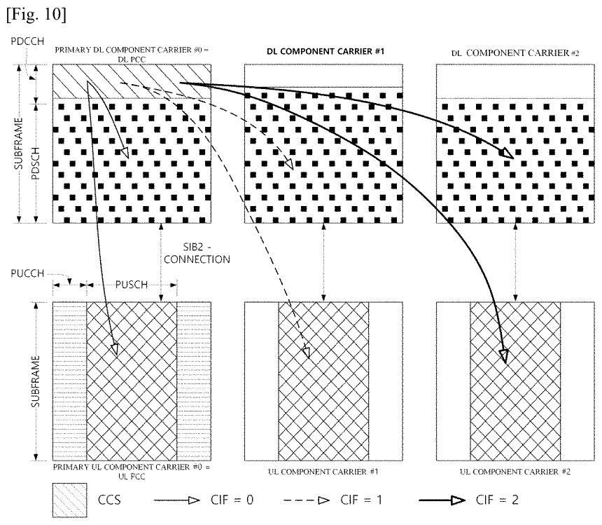

FIG. 10 is a diagram showing an example in which a cross carrier scheduling technique is applied. When cross carrier scheduling is set, the control channel transmitted through the first CC may schedule a data channel transmitted through the first CC or the second CC using a carrier indicator field (CIF). The CIF is included in the DCI. In other words, a scheduling cell is set, and the DL grant/UL grant transmitted in the PDCCH area of the scheduling cell schedules the PDSCH/PUSCH of the scheduled cell. That is, a search area for the plurality of component carriers exists in the PDCCH area of the scheduling cell. A PCell may be basically a scheduling cell, and a specific SCell may be designated as a scheduling cell by an upper layer.

In the embodiment of FIG. 10, it is assumed that three DL CCs are merged. Here, it is assumed that DL component carrier #0 is DL PCC (or PCell), and DL component carrier #1 and DL component carrier #2 are DL SCCs (or SCell). In addition, it is assumed that the DL PCC is set to the PDCCH monitoring CC. When cross-carrier scheduling is not configured by UE-specific (or UE-group-specific or cell-specific) higher layer signaling, a CIF is disabled, and each DL CC can transmit only a PDCCH for scheduling its PDSCH without the CIF according to an NR PDCCH rule (non-cross-carrier scheduling, self-carrier scheduling). Meanwhile, if cross-carrier scheduling is configured by UE-specific (or UE-group-specific or cell-specific) higher layer signaling, a CIF is enabled, and a specific CC (e.g., DL PCC) may transmit not only the PDCCH for scheduling the PDSCH of the DL CC A using the CIF but also the PDCCH for scheduling the PDSCH of another CC (cross-carrier scheduling). On the other hand, a PDCCH is not transmitted in another DL CC. Accordingly, the UE monitors the PDCCH not including the CIF to receive a self-carrier scheduled PDSCH depending on whether the cross-carrier scheduling is configured for the UE, or monitors the PDCCH including the CIF to receive the cross-carrier scheduled PDSCH.

On the other hand, FIGS. 9 and 10 illustrate the subframe structure of the 3GPP LTE-A system, and the same or similar configuration may be applied to the 3GPP NR system. However, in the 3GPP NR system, the subframes of FIGS. 9 and 10 may be replaced with slots.

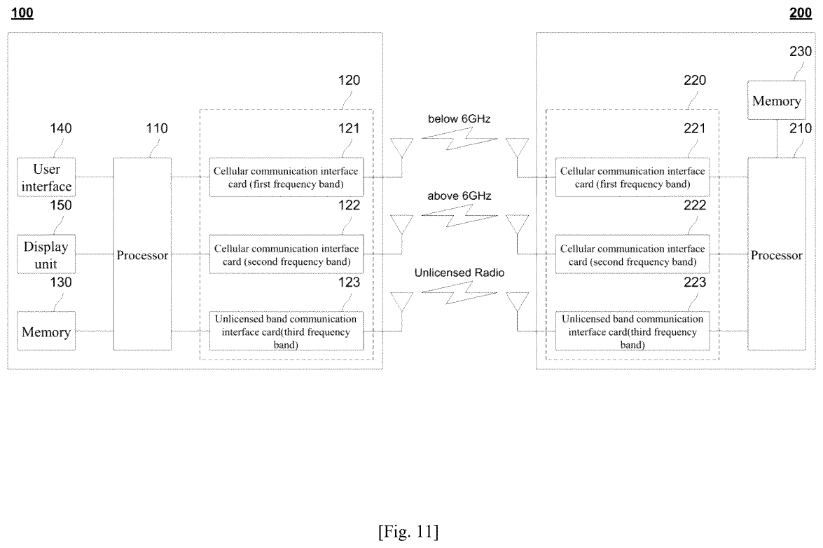

FIG. 11 is a block diagram showing the configurations of a UE and a base station according to an embodiment of the present disclosure.

In an embodiment of the present disclosure, the UE may be implemented with various types of wireless communication devices or computing devices that are guaranteed to be portable and mobile. The UE may be referred to as a User Equipment (UE), a Station (STA), a Mobile Subscriber (MS), or the like. In addition, in an embodiment of the present disclosure, the base station controls and manages a cell (e.g., a macro cell, a femto cell, a pico cell, etc.) corresponding to a service area, and performs functions of a signal transmission, a channel designation, a channel monitoring, a self diagnosis, a relay, or the like. The base station may be referred to as next Generation NodeB (gNB) or Access Point (AP).

As shown in the drawing, a UE 100 according to an embodiment of the present disclosure may include a processor 110, a communication module 120, a memory 130, a user interface 140, and a display unit 150.

First, the processor 110 may execute various instructions or programs and process data within the UE 100. In addition, the processor 110 may control the entire operation including each unit of the UE 100, and may control the transmission/reception of data between the units. Here, the processor 110 may be configured to perform an operation according to the embodiments described in the present disclosure. For example, the processor 110 may receive slot configuration information, determine a slot configuration based on the slot configuration information, and perform communication according to the determined slot configuration.

Next, the communication module 120 may be an integrated module that performs wireless communication using a wireless communication network and a wireless LAN access using a wireless LAN. For this, the communication module 120 may include a plurality of network interface cards (NICs) such as cellular communication interface cards 121 and 122 and an unlicensed band communication interface card 123 in an internal or external form. In the drawing, the communication module 120 is shown as an integral integration module, but unlike the drawing, each network interface card can be independently arranged according to a circuit configuration or usage.

The cellular communication interface card 121 may transmit or receive a radio signal with at least one of the base station 200, an external device, and a server by using a mobile communication network and provide a cellular communication service in a first frequency band based on the instructions from the processor 110. According to an embodiment, the cellular communication interface card 121 may include at least one NIC module using a frequency band of less than 6 GHZ. At least one NIC module of the cellular communication interface card 121 may independently perform cellular communication with at least one of the base station 200, an external device, and a server in accordance with cellular communication standards or protocols in the frequency bands below 6 GHz supported by the corresponding NIC module.

The cellular communication interface card 122 may transmit or receive a radio signal with at least one of the base station 200, an external device, and a server by using a mobile communication network and provide a cellular communication service in a second frequency band based on the instructions from the processor 110. According to an embodiment, the cellular communication interface card 122 may include at least one NIC module using a frequency band of more than 6 GHz. At least one NIC module of the cellular communication interface card 122 may independently perform cellular communication with at least one of the base station 200, an external device, and a server in accordance with cellular communication standards or protocols in the frequency bands of 6 GHz or more supported by the corresponding NIC module.

The unlicensed band communication interface card 123 transmits or receives a radio signal with at least one of the base station 200, an external device, and a server by using a third frequency band which is an unlicensed band, and provides an unlicensed band communication service based on the instructions from the processor 110. The unlicensed band communication interface card 123 may include at least one NIC module using an unlicensed band. For example, the unlicensed band may be a band of 2.4 GHz, 5 GHZ, 6 GHZ, 7 GHZ, or above 52.6 GHz. At least one NIC module of the unlicensed band communication interface card 123 may independently or dependently perform wireless communication with at least one of the base station 200, an external device, and a server according to the unlicensed band communication standard or protocol of the frequency band supported by the corresponding NIC module.

The memory 130 stores a control program used in the UE 100 and various kinds of data therefor. Such a control program may include a prescribed program required for performing wireless communication with at least one among the base station 200, an external device, and a server.

Next, the user interface 140 includes various kinds of input/output means provided in the UE 100. In other words, the user interface 140 may receive a user input using various input means, and the processor 110 may control the UE 100 based on the received user input. In addition, the user interface 140 may perform an output based on instructions from the processor 110 using various kinds of output means.

Next, the display unit 150 outputs various images on a display screen. The display unit 150 may output various display objects such as content executed by the processor 110 or a user interface based on control instructions from the processor 110.

In addition, the base station 200 according to an embodiment of the present disclosure may include a processor 210, a communication module 220, and a memory 230.

First, the processor 210 may execute various instructions or programs, and process internal data of the base station 200. In addition, the processor 210 may control the entire operations of units in the base station 200, and control data transmission and reception between the units. Here, the processor 210 may be configured to perform operations according to embodiments described in the present disclosure. For example, the processor 210 may signal slot configuration and perform communication according to the signaled slot configuration.

Next, the communication module 220 may be an integrated module that performs wireless communication using a wireless communication network and a wireless LAN access using a wireless LAN. For this, the communication module 220 may include a plurality of network interface cards such as cellular communication interface cards 221 and 222 and an unlicensed band communication interface card 223 in an internal or external form. In the drawing, the communication module 220 is shown as an integral integration module, but unlike the drawing, each network interface card can be independently arranged according to a circuit configuration or usage.

The cellular communication interface card 221 may transmit or receive a radio signal with at least one of the UE 100, an external device, and a server by using a mobile communication network and provide a cellular communication service in the first frequency band based on the instructions from the processor 210. According to an embodiment, the cellular communication interface card 221 may include at least one NIC module using a frequency band of less than 6 GHZ. The at least one NIC module of the cellular communication interface card 221 may independently perform cellular communication with at least one of the UE 100, an external device, and a server in accordance with the cellular communication standards or protocols in the frequency bands less than 6 GHz supported by the corresponding NIC module.

The cellular communication interface card 222 may transmit or receive a radio signal with at least one of the UE 100, an external device, and a server by using a mobile communication network and provide a cellular communication service in the second frequency band based on the instructions from the processor 210. According to an embodiment, the cellular communication interface card 222 may include at least one NIC module using a frequency band of 6 GHz or more. The at least one NIC module of the cellular communication interface card 222 may independently perform cellular communication with at least one of the base station 100, an external device, and a server in accordance with the cellular communication standards or protocols in the frequency bands 6 GHz or more supported by the corresponding NIC module.

The unlicensed band communication interface card 223 transmits or receives a radio signal with at least one of the base station 100, an external device, and a server by using the third frequency band which is an unlicensed band, and provides an unlicensed band communication service based on the instructions from the processor 210. The unlicensed band communication interface card 223 may include at least one NIC module using an unlicensed band. For example, the unlicensed band may be a band of 2.4 GHz, 5 GHZ, 6 GHZ, 7 GHZ, or above 52.6 GHz. At least one NIC module of the unlicensed band communication interface card 223 may independently or dependently perform wireless communication with at least one of the UE 100, an external device, and a server according to the unlicensed band communication standards or protocols of the frequency band supported by the corresponding NIC module.

FIG. 11 is a block diagram illustrating the UE 100 and the base station 200 according to an embodiment of the present disclosure, and blocks separately shown are logically divided elements of a device. Accordingly, the aforementioned elements of the device may be mounted in a single chip or a plurality of chips according to the design of the device. In addition, a part of the configuration of the UE 100, for example, a user interface 140, a display unit 150 and the like may be selectively provided in the UE 100. In addition, the user interface 140, the display unit 150 and the like may be additionally provided in the base station 200, if necessary.

A slot format may be configured for the UE by the base station in a TDD or unpaired spectrum system. The slot format may refer to the type of symbols in the slot. The symbol type may be at least one of a downlink symbol (DL symbol), an uplink symbol (UL symbol), or a flexible symbol. A symbol type of a slot in a radio frame may be configured for the UE by the base station. The flexible symbol may refer to a symbol that is not configured as a downlink symbol or an uplink symbol.

The UE may receive information about the type of each symbol in the slot from the base station through a cell-specific or cell-common radio resource control (RRC) signal. Alternatively, the UE may semi-statically receive information about the type of each symbol in the slot via SIB1. Furthermore, the UE may semi-statically receive information about the type of each symbol in the slot from the base station through a UE-specific UE-dedicated RRC signal. The base station may configure/set the type of each symbol in the slot for the UE by using the information about the type of each symbol in the slot.

When the UE receives the information about the type of each symbol in the slot from the base station through a cell-specific RRC signal, the information about the type of each symbol may include at least one among the period of a cell-specific slot, the number of slots including only downlink symbols starting from a cell-specific slot at which the period begins, the number of downlink symbols starting from the first symbol of a slot immediately following the last slot including only downlink symbols, the number of slots including only uplink symbols starting from the last cell-specific slot of the period, and the number of uplink symbols immediately preceding the last of slots including only uplink symbols. Furthermore, when the UE receives the information about the type of each symbol in the slot from the base station through a cell-specific RRC signal, the information about the type of each symbol may include up to two slot patterns. In this case, each of the two patterns may be applied consecutively to symbols in the time domain. The downlink symbol, the uplink symbol, and the flexible symbol configured based on the cell-specific RRC signal or SIB1 may be referred to as a cell-specific downlink symbol, a cell-specific uplink symbol, and a cell-specific flexible symbol, respectively.

When the UE receives information about the type of each symbol in the slot from the base station through a UE-specific RRC signal, the cell-specific flexible symbol may be configured as a downlink symbol or an uplink symbol. In this case, the information about the type of each symbol may include at least one among an index for a slot in a period, the number of downlink symbols starting from the first symbol in a slot indicated by the index, and the number of uplink symbols starting from the last symbol in the slot indicated by the index. In addition, for the UE, all of the symbols in the slot are configured as downlink symbols, or all of the symbols in the slot are configured as uplink symbols. The downlink symbol, the uplink symbol, and the flexible symbol configured based on the UE-specific RRC signal may be referred to as a UE-specific downlink symbol, a UE-specific uplink symbol, and a UE-specific flexible symbol, respectively.

The base station may transmit information about the slot format to the UE via a slot format indicator (SFI) in DCI format 2_0 contained in a group common (GC)-PDCCH. The GC-PDCCH may be CRC-scrambled with SFI-RNTI for UEs receiving the information about the slot format. Hereinafter, an SFI transmitted via a GC-PDCCH may be described as a dynamic SFI.

The UE may receive a dynamic SFI through GC-PDCCH to receive indication of whether symbols in a slot are cell-specific flexible symbols or UE-specific flexible symbols, downlink symbols, uplink symbols, or flexible symbols. In other words, only a flexible symbol semi-statically configured for the UE may be indicated as one of a downlink symbol, an uplink symbol, and a flexible symbol via a dynamic SFI. The UE may not expect that a semi-statically configured downlink symbol or uplink symbol will be indicated as a different type of symbol by the dynamic SFI. The UE may perform blind decoding at each monitoring period configured by the base station to receive a GC-PDCCH transmitting DCI format 2_0 including the dynamic SFI. When the UE successfully receives the GC-PDCCH by performing the blind decoding, the UE may apply information about a slot format indicated by the dynamic SFI, starting from a slot in which the GC-PDCCH has been received.

A combination of slot formats that can be indicated through a dynamic SFI may be configured for the UE by the base station. The slot format combination may be for each of 1 to 256 slots, and a slot format combination for one of the 1 to 256 slots may be configured for the UE through a dynamic SFI. The dynamic SFI may include an index indicating a slot to which the slot format combination is applied. Table 3 shows a slot format combination for each slot (see 3GPP TS38.213).

TABLE 3

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on tdd-UL-DL-ConfigurationCommon, |
| | or tdd-UL-DL-ConfigurationDedicated and, if any, on detected DCI formats |

In Table 3, D denotes a downlink symbol, U denotes an uplink symbol, and F denotes a flexible symbol. As shown in Table 3, DL/UL switching may be allowed up to two times within a slot.

In the present specification, the terms “configuration”, “setting”, and “indication” may be used interchangeably. That is, the terms “configured”, “set”, and “indicated” may have the same meaning, and similarly, the terms “is configured”, “is set”, and “is indicated” may have the same meaning.

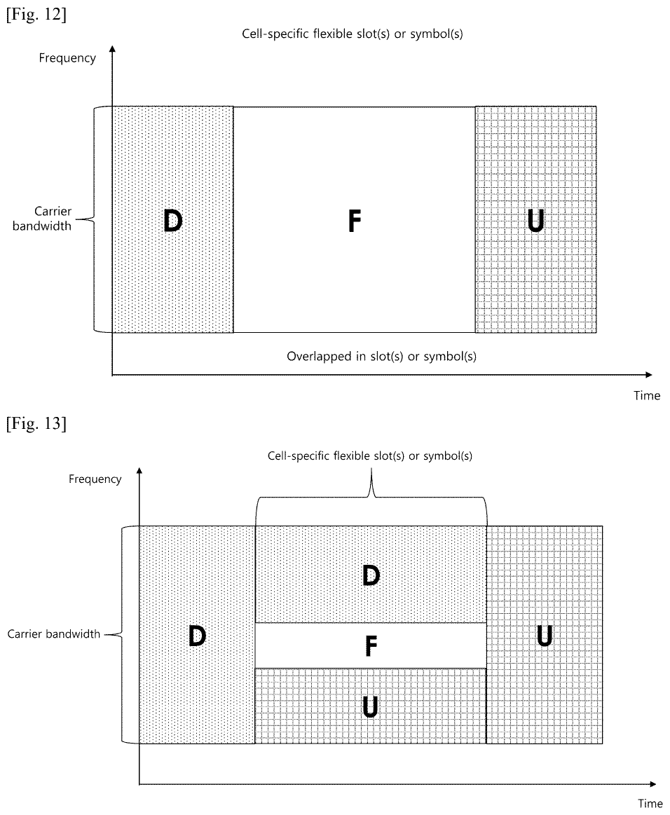

FIGS. 12 to 18 illustrate a subband configuration method according to an embodiment of the present disclosure.

In a TDD or unpaired spectrum system, when a slot format is configured or indicated for a UE, problems such as uplink coverage reduction, increased latency, and decreased capacity may arise if a limited time domain resource is allocated as an uplink resource. To address these problems, a specific time domain resource within a cell may be used for both downlink reception and uplink transmission. Even when a base station uses a specific time domain resource for both downlink reception and uplink transmission, the UE may support only half-duplex communication and perform only one operation, either downlink reception or uplink transmission, in the same specific time domain resource.

The specific time domain resource may be a cell-specific flexible symbol in a semi-statically configured slot format. This is intended to minimize inter-UE interference due to transmission and reception in different symbol types (DL/UL or UL/DL).

Referring to FIG. 12, the UE may receive a cell-specific slot configuration semi-statically. The UE may perform downlink reception or uplink transmission on a resource scheduled by the base station. A resource scheduled for PDSCH reception for a first UE and a resource scheduled for PUSCH transmission for a second UE may include the same symbols in the time domain, but may be different RBs in the frequency domain. A method by which one base station schedules multiple UEs to use a specific time domain resource for both downlink reception and uplink transmission may be inefficient when considering inter-cell interference, spectrum regulation, and power consumption for PDCCH monitoring by the UE. Hereinafter, a method for addressing this inefficiency will be described. In the present specification, a subband may be configured on a frequency domain resource within a time domain resource (slot or symbol). In this case, the frequency domain resource may be included within the carrier bandwidth of the UE.

### Spectrum Partitioning

A specific time domain resource (a cell-specific flexible slot/symbol) available for both downlink reception and uplink transmission may be configured for the UE by the base station in the form of multiple subbands on a frequency domain. The multiple subbands may be subbands of the same format or different formats. The subband formats may include a downlink subband, an uplink subband, and a flexible subband. The downlink subband may include one or more downlink RB(s), the uplink subband may include one or more uplink RB(s), and the flexible subband may include one or more flexible RB(s), wherein the downlink RB(s) may refer to resources available for downlink reception and the uplink RB(s) may refer to resources available for uplink transmission. The flexible RB(s) may refer to resources available for downlink reception and uplink transmission depending on the configuration by the base station.

(Method 1-1) When multiple subbands are configured for a UE, there may be a maximum of one subband of the same format. That is, one cell-specific flexible slot/symbol interval may include at most one downlink subband, one uplink subband, and one flexible subband, respectively. Referring to FIG. 13, a cell-specific flexible slot/symbol may include multiple subbands. In this case, the multiple subbands may include one downlink subband, one uplink subband, and one flexible subband. A guard band may be needed to minimize the impact of UL/DL interference between the downlink subband and the uplink subband. Limiting the number of subbands of the same format to one is intended to configure a downlink subband, an uplink subband, and a flexible subband while minimizing the number of guard bands, thereby increasing the efficiency of a frequency resource during downlink reception and uplink transmission.

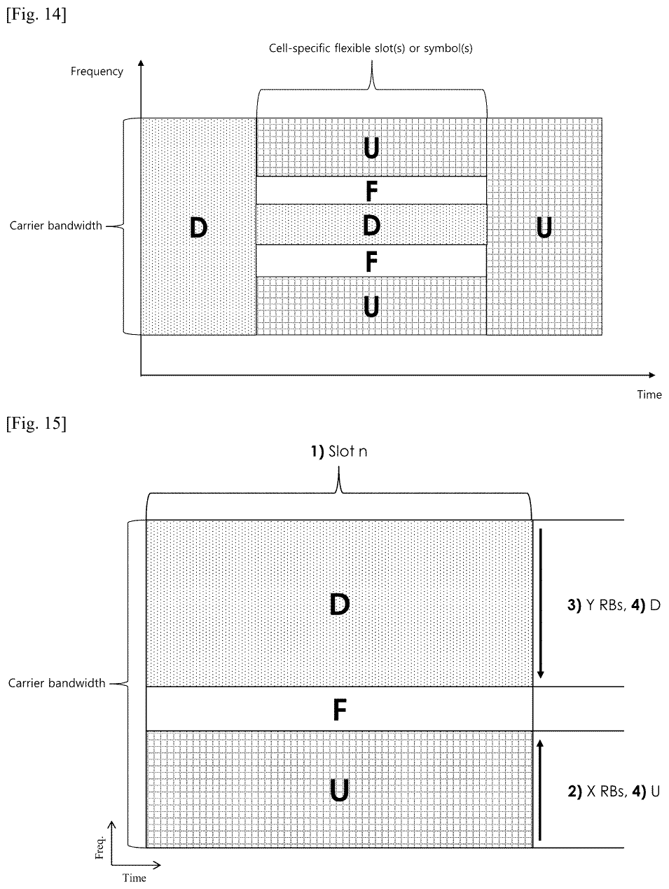

(Method 1-2) Furthermore, when multiple subbands are configured for the UE, there may be multiple subbands of the same format. That is, in one cell-specific flexible slot/symbol interval, at least one of a downlink subband, an uplink subband, and a flexible subband may be multible subbands. Referring to FIG. 14, a cell-specific flexible slot/symbol may include multiple subbands. The multiple subbands may include one downlink subband, two uplink subbands, and two flexible subbands.

The multiple subbands in methods 1-1 and 1-2 may include non-overlapping RBs in the frequency domain.

In methods 1-1 and 1-2, the flexible subband may be configured taking into account a guard band between the uplink subband and the downlink subband. That is, there may be at least one flexible subband between the uplink subband and the downlink subband. Method 1-1 may require a smaller number of guard bands compared to Method 1-2. Therefore, there may be more resources available for downlink reception and uplink transmission. Furthermore, compared to method 1-2, method 1-1 may have more frequency resources available when a CORESET resource for PDCCH monitoring is configured for the UE, thus allowing a CORESET to be flexibly configured within one downlink subband (or flexible subband). In addition, method 1-1 may also have more frequency domain resources available for uplink transmissions than method 1-2. Thus, method 1-1 may be advantageous in terms of frequency resource utilization efficiency compared to method 1-2. Hereinafter, the methods described in the present specification are based on, but not limited to, method 1-1. In the present specification, an RB in a downlink subband may be described as a downlink RB, an RB in an uplink subband may be described as an uplink RB, and an RB in a flexible subband may be described as a flexible RB.

A method by which multiple subbands are configured in the frequency domain may be applied to a cell-specific flexible slot or symbol as well as to a cell-specific downlink slot or symbol or a cell-specific uplink slot or symbol. Thus, multiple subbands may be configured for a UE in the frequency domain for a cell-specific downlink slot or symbol and a cell-specific flexible slot or symbol.

Alternatively, multiple subbands may be configured for the UE in the frequency domain for a cell-specific uplink slot or symbol and a cell-specific flexible slot or symbol.

The method by which the multiple subbands are configured in the frequency domain may be applied to a UE-specific flexible slot or symbol. Furthermore, the method by which the multiple subbands are configured in the frequency domain may be applied to a UE-specific downlink slot or symbol.

### Semi-Static Subband Format Configuration

A subband may be semi-statically configured for the UE through a cell-specific RRC signal or SIB1. The UE may configure the subband by semi-statically receiving subband configuration information from the base station. The subband configuration information may include information related to the position of the subband and information related to the type of subband (the type of RB).

(Method 2-1) The UE may receive subband configuration information from the base station to configure the number of downlink RBs and the number of uplink RBs. The subband configuration information may include at least one among an index of one of slots in a period, the number of uplink RBs starting from the first RB in a slot corresponding to the index, the number of downlink RBs, the number of downlink RBs starting from the last RB in the slot corresponding to the index, the number of uplink RBs, and information about positions of a downlink subband and an uplink subband. Among the RBs in the slot, an RB that is not configured as a downlink RB or an uplink RB may be determined to be a flexible RB. Referring to FIG. 15, 1) the index for a slot is n, 2) X RBs starting from the first RB in slot n are uplink RBs, and 3) Y RBs starting from the last RB in slot n are downlink RBs. 4) A subband including X RBs starting from the first RB in slot n may be an uplink subband, and a subband including Y RBs starting from the last RB in slot n may be a downlink subband. Alternatively, in contrast to FIG. 15, the subband including X RBs starting from the first RB in slot n may be configured as a downlink subband and the subband including Y RBs starting from the last RB in slot n may be configured as an uplink subband.

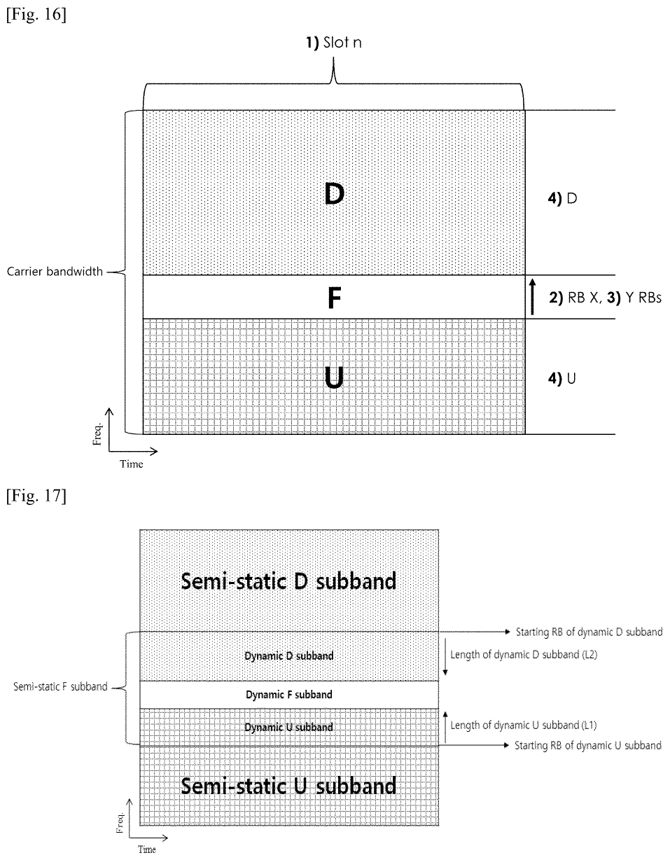

(Method 2-2) The UE may receive subband configuration information from the base station to configure the number of flexible RBs and a starting RB. The subband configuration information may include at least one among an index of one of the slots in a period, an index of the first flexible RB among flexible RBs in a slot corresponding to the index, the number of flexible RBs in the slot corresponding to the index, and information about positions of a downlink subband and an uplink subband. Among the RBs in the slot, RBs that are not configured as the flexible RBs may be determined to be a downlink RB and an uplink RB. Referring to FIG. 16, 1) the index for a slot is n, 2) the index of the first flexible RB in slot n is X, 3) Y RBs starting from X to are flexible subbands, and 4) subbands other than a flexible subband in slot n may be configured as a downlink subband and an uplink subband. That is, an uplink subband may include RBs from the first RB in slot n to an RB before the first flexible RB of the flexible subband, and a downlink subband may include RBs from the last RB in slot n to an RB after the last RB of the last flexible subband. Conversely, a downlink subband may include RBs from the first RB in slot n to the first flexible RB of the flexible subband, and an uplink subband may include RBs from the last RB in slot n to the last RB of the last flexible subband.

(Method 2-3) The UE may receive subband configuration information from the base station. Based on the subband configuring information, the UE may configure an uplink (or downlink) start RB, the number of uplink (or downlink) RBs, and the number of flexible RBs. Specifically, the subband configuring information may include information about one among: an index for one of slots in a period, a starting index of an uplink (or downlink) RB in a slot corresponding to the index, the number of uplink (or downlink) RBs in the slot corresponding to the index, and the number of flexible RBs in the slot corresponding to the index. The UE may determine that an RB which is not configured as an uplink (or downlink) RB or a flexible RB is a downlink (or uplink) RB.

The number of flexible RBs may not be configured by the base station. A predefined number of RBs may not be configured for a guard band, and the flexible subband may be determined by applying a pre-defined number of RBs for the guard band.

The flexible subband may be positioned between the downlink subband and the uplink subband. Therefore, there is the effect that the UE can determine the position of the flexible position even when the starting index of a flexible RB is not separately indicated.

In methods 2-1, 2-2, and 2-3, the subband configuration information may be transmitted commonly to UEs in a cell, wherein a downlink RB, an uplink RB, and a flexible RB configured for each UE may be configured in units of a common resource block (CRB) basis. In addition, in methods 2-1, 2-2, and 2-3, the subband configuration information may be transmitted to a specific UE in the cell, and a downlink RB, an uplink RB, and a flexible RB configured for each UE may be configured in units of a physical resource block (PRB).

Methods 2-1, 2-2, and 2-3 have the effect that it is possible to identify information about all subbands even when a UE partially receives subband configuration information. In methods 2-1 and 2-2, an RB in a semi-static downlink subband may be described as a semi-static downlink RB, an RB in a semi-static uplink subband may be described as a semi-static uplink RB, and an RB in a semi-static flexible subband may be described as a semi-static flexible RB.

The method of semi-statically configuring a subband based on methods 2-1, 2-2, and 2-3 may include a cell-specific flexible slot or symbol, may include a cell-specific downlink slot or symbol, and may include a cell-specific uplink slot or symbol. Thus, a subband may be semi-statically configured for the UE with respect to the cell-specific downlink slot or symbol and the cell-specific flexible slot or symbol. Alternatively, a subband may be semi-statically configured for the UE with respect to the cell-specific uplink slot or symbol and flexible slot or symbol. Alternatively, the method for semi-statically configuring a subband based on methods 2-1, 2-2, and 2-3 may include a UE-specific flexible slot or symbol. Furthermore, the method for semi-statically configuring a subband based on methods 2-1, 2-2, and 2-3 may include a UE-specific downlink slot or symbol.

The UE may use a cell-specific RRC signal or SIB1 or a UE-specific RRC signal to perform the method for semi-statically configuring a subband based on methods 2-1, 2-2, and 2-3.

There are multiple indexes of one of slots in a period, included in the above-described subband configuration. That is, a subband may be configured for the UE with respect to multiple slots in the period.

### Dynamic Subband Format Indication

A subband format may be configured (set/indicated) for a UE through dynamic signaling. That is, the subband format may be configured for the UE from DCI transmitted via a PDCCH. When a semi-static format is not configured for the UE, the UE may consider all frequency domain resources in a slot to be semi-static flexible subbands. A subband format may be dynamically indicated to the UE through

DCI. That is, a semi-static downlink subband and a semi-static uplink subband configured through the semi-static format configuration may not be indicated as a different format through DCI. When no semi-static subband format is configured for the UE, the UE may apply a subband format indicated through DCI for a cell-specific flexible slot/symbol. The subband format indicated through DCI may be described as a dynamic subband.

Sub-band RB(s) may be indicated to the UE in the frequency domain through an RIV method, which is a method for indicating consecutive scheduled resources in the frequency domain in an NR system. The RIV may be a value obtained by joint-coding a starting RB index and the number of consecutively allocated RBs. Mathematical Expression 1 shows a method for determining the RIV (see 3GPP TS38.214)

$$if ( {L}_{RBs} - 1 ) \leq ⌊ {N}_{BWP}^{size} / 2 ⌋ then \qquad [ Mathematical Expression 1 ]$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} + 1 ) + ( {N}_{BWP}^{size} - 1 - {RB}_{start} )$$

$$where {L}_{RBs} >= 1 and shall not exceed {N}_{BWP}^{size} - {RB}_{start} .$$

Here, L_{RBs} may be the number of consecutively allocated RBs, RBₛₜₐᵣₜ may be the starting RB index, and N_{BWP}^{size} may be the BWP size of the UE. For example, when N_{BWP}^{size} is 4, the expressible starting RB index and the number of consecutively allocated RBs may be as shown in Table 4.

TABLE 4

S

| L | 0 | 1 | 2 | 3 |
|---|---|---|---|---|
| 1 | 0 | 1 | 2 | 3 |
| 2 | 4 | 5 | 6 | |
| 3 | 8 | 9 | | |
| 4 | 7 | | | |

In Table 4, S indicates the starting RB index and L is the number of consecutively allocated RBs. According to Table 4, when N_{BWP}^{size} is 4, the RIV value may be one of 0 to 9. The UE may determine the starting RB index and the number of consecutively allocated RBs by the indicated RIV value. For example, when it is indicated to the UE that an RIV value is 5, the UE may identify that two consecutive RBs have been allocated starting from RB #1 in the frequency domain.

The following describes a method by which, for a UE, a subband format in the frequency domain is indicated by the base station in an RIV form through DCI.

(Method 3-1) The number of downlink RBs and the number of uplink RBs as subband configuration information may be indicated to a UE by a base station. The number of downlink and uplink RBs may be indicated as one joint-coded value to the UE. When the one value is obtained in an RIV form, the one value may be determined through Mathematical Expression 2.

$$if {L}_{RBs}^{2} \leq ⌊ {N}_{F}^{size} / 2 ⌋ then \qquad [ Mathematical Expression 2 ]$$

$$RIV = ( {N}_{F}^{size} + 1 ) {L}_{RBs}^{2} + {L}_{RBs}^{1}$$

$$else$$

$$RIV = ( {N}_{F}^{size} + 1 ) ( {N}_{F}^{size} + 1 - {L}_{RBs}^{2} ) + ( {N}_{F}^{size} - {L}_{RBs}^{1} )$$

$$where {L}_{RBs}^{1} >= 0 , {L}_{RBs}^{2} >= 0 , and {L}_{RBs}^{1} + {L}_{RBs}^{2} shall not exceed {N}_{F}^{size} .$$

Here, L_{RBs}¹ may indicate the number of consecutively allocated first RBs, and RBs may indicate the number of consecutively allocated second RBs. When a subband format is semi-statically configured for the UE, N_{F}^{size} may be the size of a flexible subband in the semi-statically configured subband format. When a subband format is not semi-statically configured for the UE, N_{F}^{size} may be the size of the entire carrier bandwidth. For example, when N_{F}^{size} is 4, the number of two consecutively allocated RBs may be as shown in Table 5.

TABLE 5

| | L1 | | | | |
|---|---|---|---|---|---|
| L2 | 0 | 1 | 2 | 3 | 4 |
| 0 | 0 | 1 | 2 | 3 | 4 |
| 1 | 5 | 6 | 7 | 8 | |
| 2 | 10 | 11 | 12 | | |
| 3 | 14 | 13 | | | |
| 4 | 9 | | | | |

In Table 5, L1 may be the number of consecutively allocated first RBs and L2 may be the number of consecutively allocated second RBs. According to Table 5, when N_{F}^{size} is 4, the RIV value may be any one value among 0 to 14. The UE may determine the number of consecutively allocated RBs in downlink and uplink subbands by the indicated RIV value. That is, the UE may determine L1 as the number of consecutively allocated RBs in the uplink subband and L2 as the number of consecutively allocated RBs in the downlink subband. Conversely, the UE may determine L1 as the number of consecutively allocated RBs in the downlink subband and L2 as the number of consecutively allocated RBs in the uplink subband.

When the UE determines L1 and L2 as the number of RBs consecutively allocated to the uplink (or downlink) subband and the downlink (or uplink) subband, respectively, the UE may implicitly determine the starting RB index of each subband based on the semi-statically configured subband format. Specifically, when L1 and L2 indicated for a semi-static flexible subband are applied according to method 3-1, the starting RB of the downlink subband may be determined to be an RB before or after a semi-statically configured cell-specific downlink subband, and the starting RB of the uplink subband may be determined to be an RB after or before a semi-statically configured cell-specific uplink subband. Furthermore, in the semi-static flexible subband, RB(s) that are not determined to be a dynamic downlink subband and a dynamic uplink subband may be determined to be a dynamic flexible subband. Referring to FIG. 17, it may be indicated to the UE that for a semi-static flexible subband, L1 represents the number of RBs consecutively allocated to a dynamic uplink subband and L2 represents the number of RBs consecutively allocated to a dynamic downlink subband. Furthermore, in the semi-static subband configuration, a semi-static uplink subband may include RBs from the first RB in slot n to an RB before the first dynamic subband RB (a dynamic uplink (or downlink) subband RB), and a semi-static downlink subband may include RBs from the last RB in slot n to an RB after the dynamic subband RB (the dynamic uplink (or downlink) subband RB). Thus, the UE may determine that L1 RBs starting from an RB after the semi-statically configured uplink subband are the dynamic uplink subband, and that the L2 RBs starting from an RB before the semi-static downlink subband are the dynamic downlink subband. The UE may determine that RBs in the semi-static flexible subband, which are not dynamically indicated as a downlink subband or an uplink subband, are a dynamic flexible subband.

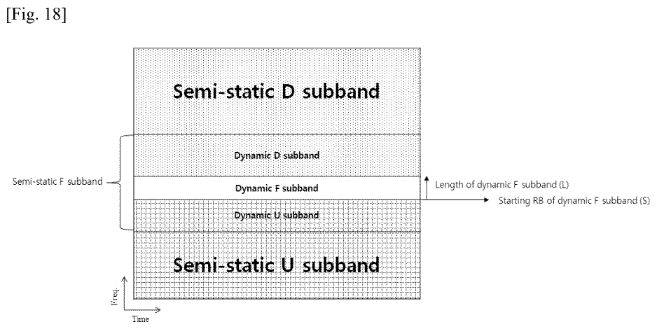

(Method 3-2) An index of a starting RB of a flexible subband and the number of RBs as subband configuration information may be indicated to a UE. The index of the starting RB of the flexible subband and the number of RBs may be indicated as one joint-coded value for the UE. When the one value is determined in an RIV form, the one value may be obtained through Mathematical Expression 1. In this case, N_{F}^{size} is used instead of N_{BWP}^{size} in Mathematical Expression 1, and N_{F}^{size} is the same as defined in Mathematical Expression 2. Furthermore, an RB that is not determined as a dynamic flexible subband may be determined as a dynamic downlink subband and a dynamic uplink subband. In this case, the dynamic downlink subband and the dynamic uplink subband may include RBs consecutive to a semi-static downlink subband and a semi-static uplink subband, which are semi-sttically configured, in the frequency domain. Referring to FIG. 18, a dynamic flexible subband may be positioned within a semi-static flexible subband. S may be an index of a starting RB of the dynamic flexible subband, and L may be the number of RBs consecutively allocated to the dynamic flexible subband. The UE may determine the dynamic flexible subband based on the index of the starting RB and the number of consecutive RBs, configured for the semi-static flexible subband. The UE may determine that RBs of the semi-static flexible subband, which are not configured as the dynamic flexible subband, are RBs of the dynamic downlink subband and the dynamic uplink subband. The UE may determine that RBs, which are consecutive to the semi-static downlink subband, among the RBs that are not configured for the configuration of the dynamic flexible subband, are RBs of the dynamic downlink subband. The UE may determine that RBs, which are consecutive to the semi-static uplink subband, among RBs not indicated as the dynamic flexible subband, are RBs of the dynamic uplink subband.

The unit of RB in methods 3-1 and 3-2 may be a PRB.

(Method 3-3) A base station may indicate, to a UE, an index of a starting RB in an uplink (or downlink) subband and the number of RBs. One value, in which the index of the starting RB and the number of RBs are joint-coded, may be indicated for the UE by the base station. In this case, the one joint-coded value may be obtained through Mathematical Expression 1 above. The UE may determine that RBs, which are not indicated as uplink (or downlink) RBs, are downlink (or uplink) RBs or flexible RBs. Furthermore, the number of flexible RBs may be the number of flexible RBs that are semi-statically configured or determined by the UE. The UE may determine that an RB, which is not an uplink (or downlink) RB or a flexible RB, is a downlink (or uplink) RB.

The flexible subband may be positioned between the downlink subband and the uplink subband. Therefore, the UE may identify the position of the flexible subband without ambiguity, even when a starting index of a flexible RB is not separately indicated.

In methods 3-1, 3-2, and 3-3, the dynamic downlink subband, the dynamic uplink subband, and the dynamic flexible subband may include consecutive RBs in the frequency domain.

In methods 3-1, 3-2, and 3-3, the subband configuration information may be transmitted commonly to UEs in a cell, wherein a downlink RB, an uplink RB, and a flexible RB configured for each UE may be configured in units of common resource blocks (CRBs).

When a dynamic subband format is indicated to a UE according to method 3-1, 3-2, or 3-3, information about the subband format may be transmitted to the UE through group-common signaling. For example, the dynamic subband format information may be included in DCI format 2_0 used in legacy NR. DCI format 2_0 may be transmitted through GC-PDCCH, and the GC-PDCCH may be CRC-scrambled with SFI-RNTI for UEs receiving the subband format information. The UE may perform blind decoding at each monitoring period configured by the base station to receive the GC-PDCCH including the DCI format 2_0 including the subband format information. When the UE successfully receives GC-PDCCH by performing blind decoding, the UE may apply the subband format information during the monitoring period configured by the base station starting from a slot in which the PDCCH has been received. In addition, the dynamic subband format information may be transmitted through a new DCI format (e.g., DCI format 2_x) rather than the DCI format used in legacy NR. DCI format 2_x may be transmitted through a GC-PDCCH, and the GC-PDCCH may transmit a slot formation indication in frequency domain (SFI-F) to notify UEs, which receive the subband format information, of a slot format in the frequency domain. SFI-F may be CRC-scrambled with SFIF-RNTI. To receive the PDCCH including DCI format 2_x, blind decoding may be performed at each monitoring period configured by the base station. When the UE successfully receives the GC-PDCCH by performing blind decoding, the UE may apply the subband format information during the monitoring period configured by the base station starting from a slot in which the GC-PDCCH has been received.

When a dynamic subband format is configured for a UE according to method 3-1, the payload size of DCI format 2_0 or DCI format 2_x including dynamic subband format information may be ┌log₂(N_{F}^{size}+1)(N_{F}^{size}+2)/2)┐ bits. When a dynamic subband format is configured for a UE according to method 3-2, the payload size of DCI format 2_0 or DCI format 2_x including dynamic subband format information may be ┌log₂(N_{F}^{size}(N_{F}^{size}+1)/2)┐ bits. When a dynamic subband format is configured for a UE according to method 3-3, the payload size of DCI format 2_0 or DCI format 2_x including dynamic subband format information may be ┌log₂(N_{BWP}^{size} (N_{BWP}^{size}+1)/2)┐ bits.

An RB in the dynamic downlink subband determined according to method 3-1, 3-2, or 3-3 may be described as a dynamic downlink RB, an RB in the dynamic uplink subband may be described as a dynamic uplink RB, and an RB in the dynamic flexible subband may be described as a dynamic flexible RB.

The method for dynamically indicating a subband based on method 3-1, 3-2, or 3-3 may be applied to a cell-specific flexible slot or symbol, and may be applied to a cell-specific downlink slot or symbols or uplink slot or symbol. Thus, for a cell-specific downlink slot or symbol and a cell-specific flexible slot or symbol, a subband may be dynamically indicated to a UE. In addition, for a cell-specific uplink slot or symbol, a subband may be dynamically indicated to the UE.

The method for dynamically configuring a subband for a UE based on method 3-1, 3-2, or 3-3 may be applied to a UE-specific flexible slot or symbol. In addition, the method for dynamically configured a subband for a UE, based on method 3-1, 3-2, or 3-3, may be applied to a UE-specific downlink slot or symbol.

A base station may instruct a UE activate or deactivate (release) the UE's subband operation through MAC signaling or dynamic signaling. That is, a subband for which the subband operation is activated or deactivated through dynamic signaling may be a cell-specific flexible slot or a cell-specific downlink slot. The UE may receive information to activate or release the subband operation based on real-time changing channel conditions from the base station through a PDSCH including MAC CE via MAC signaling or through DCI of a PDCCH via L1 dynamic signaling. The UE may activate or release (may not activate) the subband operation from a specific time point. When the UE has received a PDSCH including MAC CE through MAC signaling, the specific time point may be a slot in which the UE has received the PDSCH, or a slot in which the UE has confirmed the reception of the PDSCH and transmitted HARQ-ACK corresponding to the PDSCH. Alternatively, when the UE has received L1 dynamic signaling, the specific time point may be the earliest downlink slot or symbol in the time domain after a slot at which the UE received DCI, the earliest flexible slot or symbol in the time domain after the slot at which the UE received the DCI, a downlink slot or symbol indicated by the DCI, or a flexible slot or symbol indicated by the DCI. Hereinafter, a description will be made of the activation or release of a subband operation depending on whether a semi-static subband format is configured. In the present specification, the subband operation may refer to an operation when a subband is used for an uplink.

i) In the Case where a Semi-Static Subband Format has been Configured for a UE by a Base Station

When a semi-static subband format has been configured for a UE by a base station, the UE is additionally instructed to activate or release a subband operation through MAC signaling or dynamic signaling. When the UE is configured by the base station to perform a subband operation, but is instructed to release the subband operation through MAC signaling or dynamic signaling, the UE may not perform the subband operation from a first specific time point. When the UE is instructed to release a subband operation and is then instructed to activate the subband operation through MAC signaling or dynamic signaling, the UE may perform the subband operation again from a second specific time point. The first specific time point and the second specific time point may be one of the specific time points described above. In this case, resource allocation for the subband operation (e.g., a downlink RB, an uplink RB, or a flexible RB) may follow a subband format semi-statically configured for the UE.

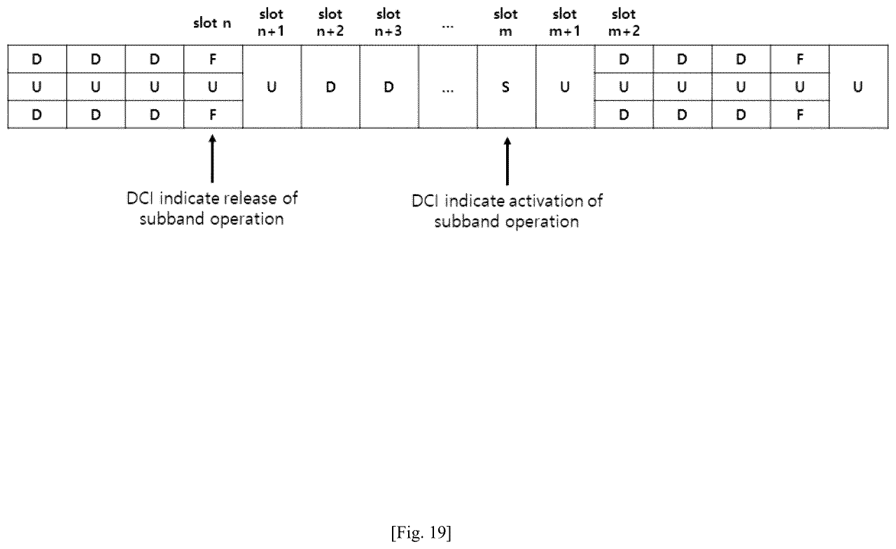

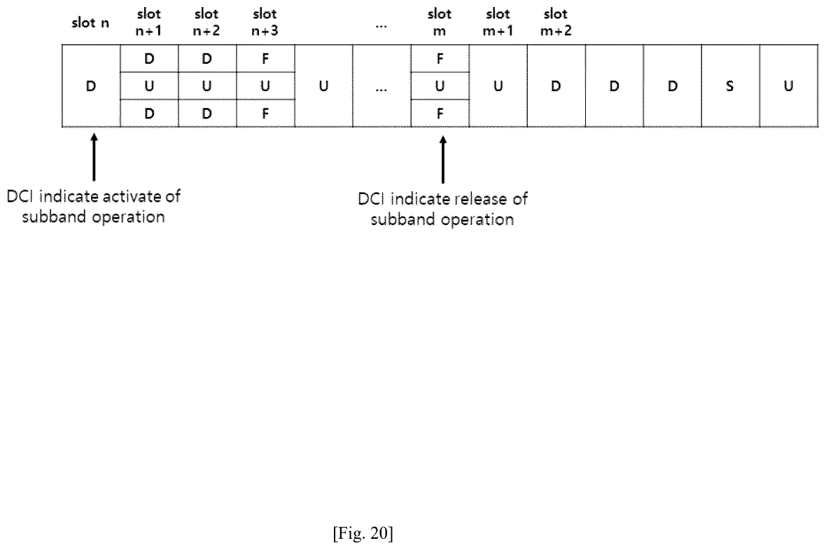

FIGS. 19 and 20 illustrate a method for activating or releasing a subband according to an embodiment of the present disclosure.

Referring to FIG. 19, due to insufficient uplink coverage during initial cell access, a semi-static subband format may be configured for a UE by a base station so that the UE performs a subband operation for uplink, but subsequently uplink coverage is improved or downlink traffic increases, thereby requiring resource allocation for downlink reception. The UE may receive MAC signaling or dynamic signaling in slot n from the base station, and may be instructed to release the subband operaton. In this case, when a specific time point at which the subband operation is released is slot n+2, the UE may not use a downlink slot or symbol, or a flexible slot or symbol, as a subband for uplink from slot n+2.

After the UE has released the subband operaton for uplink, resource allocation for uplink transmission may be again required due to insufficient coverage of the UE. The UE may receive, from the base station, MAC signaling or dynamic signaling that activates subband operation in slot m. In this case, when a specific time point at which the subband operation is activated is slot m+2, the UE may use a downlink slot or symbol, or a flexible slot or symbol, as a subband for uplink from slot m+2. In this case, the subband resource allocation for uplink transmission may be determined based on a semi-static subband format.

In other words, whether the UE uses a subband for uplink may be indicated (activated or released) through MAC signaling or dynamic signaling depending on channel conditions. In this case, the resource allocation for the subband may reuse a semi-static configuration, and thus the subband operation may be indicated to the UE without additional signaling overhead.

ii) In the Case where a Semi-Static Subband Format has not been Configured for a UE by a Base Station

When a semi-static subband format is not configured for the UE by the base station, the UE may receive information about whether to activate or release a subband operation and information about subband resource allocation through MAC signaling or dynamic signaling. When the UE is instructed to activate the subband operation through MAC signaling or dynamic signaling, the UE may use a subband for uplink transmission from a specific time point. In this case, information about resource allocation for the subband operation (i.e., a downlink RB, an uplink RB, or a flexible RB) may be included in MAC CE of the MAC signaling or in DCI of the dynamic signaling. The UE may receive the information about resource allocation for the subband operation, based on method 3-1, 3-2, or 3-3. Furthermore, when the UE is instructed to release the subband operation through MAC signaling or dynamic signaling, the UE may not use a subband for uplink transmission from a time point at which the UE receives the MAC CE or the DCI.

Referring to FIG. 20, due to insufficient uplink coverage during initial cell access, a semi-static subband format may not have been configured for a UE by a base station so that the UE performs a subband operation for uplink, but subsequently, resource allocation for uplink transmission may be required due to the insufficient uplink coverage. The UE may receive information to activate the subband operation from the base station through MAC CE of MAC signaling or DCI of dynamic signaling in slot n. When a specific time point at which the subband operation is activated is slot n+1, the UE may use a subband for uplink transmission in a downlink slot or symbol, or in a flexible slot or symbol, from slot n+1. In this case, information about the resource allocation (i.e., a downlink RB, an uplink RB, or a flexible RB) for the subband operation may be included in the MAC CE of the MAC signaling or in the DCI of the dynamic signaling. The UE may receive the information about resource allocation for the subband operation based on method 3-1, 3-2, or 3-3.

After the UE is instructed to activate the subband operation for uplink, the UE's uplink coverage may be improved or the downlink coverage may be insufficient, thereby requiring resource allocation for downlink reception. The UE may be indicated by the base station to release the subband operation through MAC signaling or dynamic signaling in slot m. When a specific time point at which the subband operation is released is slot m+2, the UE may not use a subband for uplink transmission in a downlink slot or symbol, or in a flexible slot or symbol, from slot m+2.

In other words, even when a semi-static subband format to operate as a subband during the initial cell access has not been configured for the UE by the base station, whether to activate the subband may be indicated through dynamic signaling, depending on subsequent channel conditions. The dynamic signaling may include resource allocation information regarding the subband.

### Method for Indicating Active DL/UL BWP

Hereinafter, a description will be made of a method by which an active BWP is indicated when a subband format is semi-statically or dynamically configured for a UE.

When the UE is operating in a TDD or unpaired spectrum system, a maximum of four downlink/uplink BWP pairs may be configured for the UE by the base station for one carrier (or cell). In addition, the base station may instruct the UE to activate one of the configured downlink/uplink BWP pairs. Information instructing the UE to activate the one downlink/uplink BWP pair may be included in a bandwidth part indicator (BPI) field in DCI that schedules a PDSCH or a PUSCH. Thus, the UE may receive the DCI scheduling the PDSCH or the PUSCH from the base station and identify a downlink/uplink BWP pair activated based on the BPI field. The UE may not receive or transmit a channel/a signal on time-frequency resources other than the active BWP. In addition, the UE may not perform PDCCH monitoring on the time-frequency resources other than the active BWP. In other words, the UE may perform downlink reception or PDCCH monitoring on time-frequency resources within an active downlink BWP, and uplink transmission on time-frequency resources within an active uplink BWP. When uplink/downlink subbands are included within active downlink/uplink BWPs, the UE may not perform downlink reception on the uplink subband and may not perform uplink transmission on the downlink subband. Furthermore, when the UE performs PDCCH monitoring in the uplink subband, this may cause inefficient power consumption by the UE.

To address these problems, when a subband format is configured or indicated for the UE, the active downlink BWP may be instructed to include a downlink subband and a flexible subband, and the active uplink BWP may be instructed to include an uplink subband and flexible subband. That is, the base station may insturct the UE to configure the active BWP to include a flexible subband and the same subband format as the subband format configured through the BPI field in the DCI for a configured subband and/or symbol. The UE may perform only downlink reception or PDCCH monitoring in the downlink subband, and may perform only uplink transmission in the uplink subband. However, in the flexible subband, the UE may perform downlink reception, PDCCH monitoring, or uplink transmission. Thus, the base station may configure the active BWP to include a subband and a flexible subband of at least the same format as a pre-configured subband format.

### BWP-Based Subband Allocation

The semi-static subband format configuration and dynamic subband format indication method may include a method by which the base station configures or indicates an uplink subband, a downlink subband, and a flexible subband within one active BWP for the UE.

Hereinafter, a description will be made of a method by which a UE perform a subband operation by extending the existing methods: i) the method for indicating the number of BWPs activated (e.g., 1 or 2); and ii) the method for configuring a BWP (e.g., a method for configuring slots or symbols of the same type (including downlink RBs or uplink RBs)).

(Method 4-1) A base station may instruct a UE to activate multiple BWPs among configured BWPs. The BWPs instructed to be activated by the base station may be configured with different slot formats in the time domain. Thus, the same one slot or symbol may include both an uplink RB for uplink transmission and a downlink RB for downlink reception.

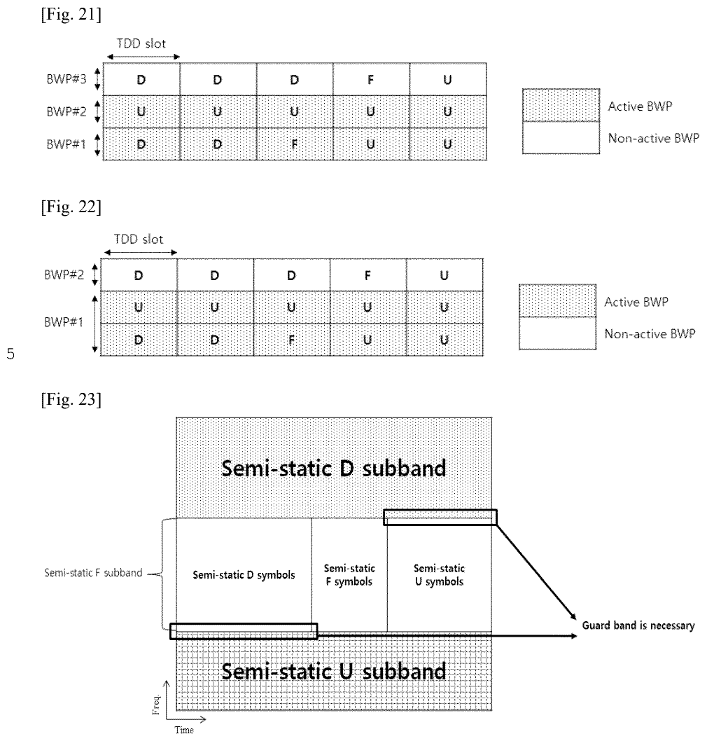

FIGS. 21 and 22 illustrate a BWP configuration in a TDD system according to an embodiment of the present disclosure.

Referring to FIG. 21, in a TDD system, three DL/UL BWP pairs (BWP #1, BWP #2, and BWP #3) for one carrier (or cell) may be configured for a UE. Subsequently, the UE may be indicated by a base station to activate two DL/UL BWP pairs (BWP #1 and BWP #2) of the configured BWPs through DCI. Therefore, BWP #1 and BWP #2 indicated through the DCI may be activated, and the UE may perform downlink reception or uplink transmission in the time-frequency resources within the activated BWP #1 and BWP #2. In this case, each of the activated BWPs may include a slot or symbol including an uplink RB and a downlink RB.

Conventionally, a UE may be instructed to activate only one BWP among configured BWPs. Therefore, depending on the slot format of the activated BWP, only one type of RB, either an uplink RB or a downlink RB, may be included in one slot. However, according to method 4-1, the base station may instruct the UE to activate multiple BWPs, and the multiple activated BWPs may be configured with different slot formats. In addition, the same slots or symbols may include both uplink RBs and downlink RBs.

(Method 4-2) A base station may configure a UE to include multiple slot formats within one BWP. That is, the base station may configure one BWP to include both an uplink RB and a downlink RB, and when it is indicated to a UE that the one BWP is activated, the one BWP may include a slot or symbol that includes both an uplink RB and a downlink RB.

Referring to FIG. 22, in a TDD system, two DL/UL BWP pairs (BWP #1 and BWP #2) may be configured for a UE in one carrier (or cell). In this case, slot formats for BWP #1 may be configured differently in the frequency domain. A base station may indicate, through DCI, the UE to activate one DL/UL BWP pair, BWP #1, among the configured BWPs. Thus, in the time-frequency resources within BWP #1 activated through the DCI, the UE may perform downlink reception or uplink transmission. The activated BWP #1 may include a slot or symbol including an uplink RB and a downlink RB.

Conventionally, a frequency domain within one BWP may be configured to include only one slot format. Thus, depending on the slot format of an activated BWP, only one type of RB, cither an uplink RB or a downlink RB, may be included in one slot. However, according to method 4-2, a base station may configure one BWP to include multiple slot formats for a UE, and may instruct the UE to activate the BWP that includes the multiple slot formats. In this case, the activated BWP may include a slot or symbol that includes both an uplink RB and a downlink RB.

According to methods 4-1 and 4-2, the base station may configure an additional BWP for the UE compared to the conventional method. Conventionally, in a TDD system, a base station may configure up to four DL/UL BWP pairs for a UE in one carrier (or cell). However, according to methods 4-1 and 4-2, the base station may configure a larger number of DL/UL BWP pairs than the conventional method.

### Subband Format Configuration/Indication and Slot Format Configuration/Indication

Hereinafter, a description will be made of a UE operation when slot format information, semi-statically configured or dynamically indicated to the UE, and subband format information, semi-statically configured or dynamically indicated to the UE, are configured or indicated on the same resource.

FIGS. 23 to 27 illustrate a method for configuring a subband according to an embodiment of the present disclosure.

(Method 5-1) Method 5-1 relates to an operation performed by a UE when a semi-static cell-specific subband format and a semi-static UE-specific slot format are configured for the same cell-specific flexible slot or symbol that is semi-statically configured.

i) When a semi-static subband format is configured, a UE may expect that a semi-static UE-specific slot format will not be configured. Furthermore, when a semi-static UE-specific slot format is configured, the UE may expect that a semi-static subband format will not be configured. In other words, the UE may expect that a semi-static subband format configuration and a semi-static slot format configuration will not conflict for the same semi-static cell-specific flexible symbol. This may imply that when a specific time domain resource is divided into multiple subbands, the specific time domain resource is not divided into different types of symbols in the time domain.

ii) A UE may apply a semi-static UE-specific slot format to a semi-static flexible subband. Referring to FIG. 23, the UE may apply a semi-statically configured UE-specific slot format to a semi-statically configured cell-specific flexible subband. Thus, the semi-static flexible subband may be divided into semi-static downlink/uplink/flexible slots/symbols in the time domain. In the case of ii), different types of symbols may be allocated in the time domain even within a subband, enabling more flexible utilization and scheduling of time and frequency resources. When the semi-static flexible subband is divided into semi-static downlink/uplink/flexible symbols, the semi-static flexible subband may be divided into symbols of the same type within the same slot. That is, the same slot may include only symbols of the same type, but not symbols of different types. The same slot may include symbols of the same type. When a semi-static flexible subband is divided into semi-static downlink/uplink/flexible symbols, guard bands may be required between RBs of different types of subbands. Referring to FIG. 23, a guard band may be required between a semi-static downlink subband and a semi-static uplink slot or symbol, and a guard band may be required between a semi-static uplink subband and a semi-static downlink slot or symbol. A base station may configure the number of RBs for the guard bands for the UE. Alternatively, the number of RBs for the guard band may be predefined, and the UE may use the predefined number of RBs for the guard bands.

(Method 5-2) Method 5-2 relates to an operation performed by a UE when a semi-static cell-specific subband format is configured for the same cell-specific flexible slot or symbol that is configured semi-statically, and when a dynamic SFI is indicated for the same symbols.

i) When a semi-static subband format is configured, the UE may expect that dynamic SFIs will not be indicated for the same resource. When a specific time domain resource is divided into multiple subbands, the specific time domain resource may not be divided into symbols of different types in the time domain.

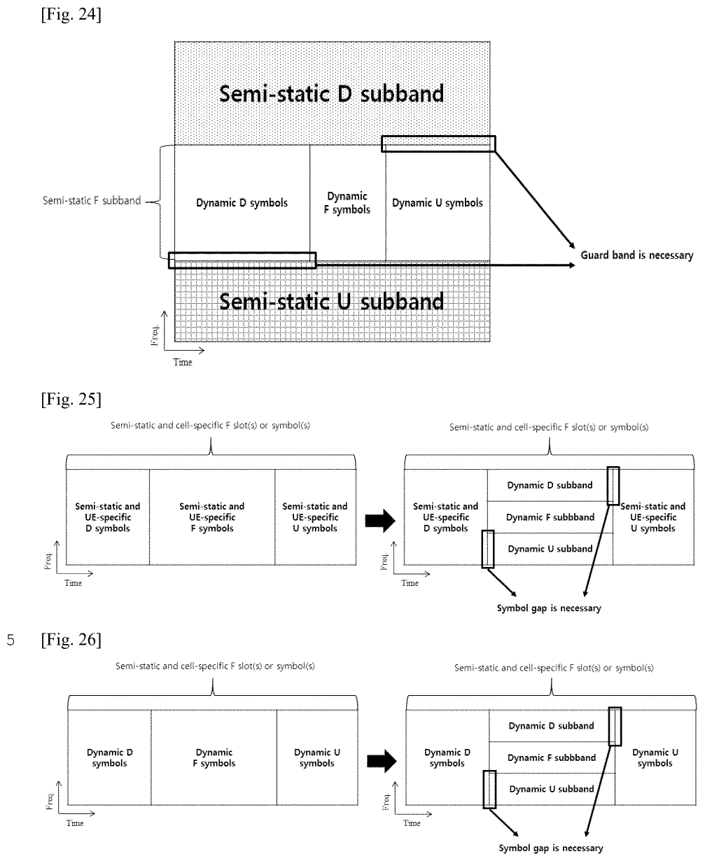

ii) The UE may apply a dynamic SFI when a semi-static subband format is configured. Referring to FIG. 24, the UE may apply a dynamic SFI to a semi-statically configured cell-specific flexible subband. Thus, the semi-static flexible subband may be divided into dynamic downlink/uplink/flexible slots or symbols in the time domain. In the case of ii), different types of symbols may be allocated in the time domain even within a subband, enabling more flexible utilization and scheduling of time and frequency resources in a cell. When the semi-static flexible subband is divided into semi-static downlink/uplink/flexible symbols, the same type of symbols may be included in the same slot. That is, symbols within the same slot may not be indicated as different types of symbols. When the semi-static flexible subband is divided into dynamic downlink/uplink/flexible symbols, guard bands may be required between RBs of different types of subbands. Referring to FIG. 20, a guard band may be required between a semi-static downlink subband and a dynamic uplink slot or symbol, and a guard band may be required between a semi-static uplink subband and a dynamic downlink slot or symbol. A base station may configure the number of RBs for the guard bands for the UE. Alternatively, the number of RBs for the guard bands may be predefined, and the UE may use the predefined number of RBs for the guard bands.

(Method 5-3) Method 5-3 relates to an operation performed by a UE when a semi-static UE-specific slot format is configured for the same cell-specific flexible slot or symbol that is configured semi-statically, and when a dynamic subband format is indicated for the same slot or symbol.

i) The UE may expect that a dynamically indicated subband format will not be indicated for a semi-statically configured UE-specific flexible slot or symbol. Since the UE-specific flexible slot or symbol may be configured differently among UEs in a cell, the UEs may expect not to be further divided into subbands to prevent interference between the UEs in the cell.

ii) The UE may apply a dynamically indicated subband format to a semi-statically configured UE-specific flexible slot or symbol. Referring to FIG. 25, the UE may apply a dynamically indicated subband format to a semi-statically configured cell-specific flexible slot or symbol as well as to a UE-specific flexible slot or symbol. This has the effect of enabling more flexible resource utilization and scheduling. When semi-static UE-specific flexible slots or symbols are divided into dynamic downlink/uplink/flexible subbands, a gap for DL/UL switching may be required between a downlink symbol and an uplink symbol. In this case, the gap may be a symbol unit. Referring to FIG. 25, a gap may be required between a semi-static downlink symbol and a dynamic uplink subband. Also, a gap may be required between a dynamic downlink subband and a semi-static uplink symbol. A base station may configure the number of symbols for the gaps for the UE. Alternatively, the number of symbols for the gaps may be predefined, and the UE may use the predefined number of symbols for the gap.

(Method 5-4) Method 5-4 relates to an operation performed by a UE when a dynamic subband format and a dynamic SFI are indicated for the same cell-specific flexible slot or symbol that is semi-statically configured.

i) When a dynamic subband format is indicated, a UE may expect that a dynamic SFI will not be indicated. Alternatively, when a dynamic SFI is indicated, the UE may expect that a dynamic subband format will not be indicated. In other words, the UE may expect that a dynamic subband format indication and a dynamic slot format indication will not conflict for the same semi-static cell-specific flexible slot or symbol(s). This implies that the flexibility to dynamically indicate both the subband format and the slot format simultaneously is not required, and thus the UE may expect that only information about one of the two formats will be dynamically indicated.

ii) The UE may apply a dynamic subband format to a flexible slot or symbol indicated by a dynamic SFI. Referring to FIG. 26, the UE may determine dynamic downlink/uplink/flexible slots or symbols by applying a dynamic SFI indicated for a semi-statically configured cell-specific flexible slot or symbol. The UE may determine dynamic downlink/uplink/flexible subbands by applying an indicated dynamic subband format to the dynamic flexible slots or symbols determined by using the dynamic SFI. Transmission/reception of a signal configured by a higher layer (e.g., reception of PDSCH, reception of CSI-RS, transmission of PUCCH, transmission of PUSCH, transmission of PRACH, or transmission of SRS) may be canceled by the dynamic SFI. However, when a specific format is again indicated as the dynamic subband format, the UE may perform the canceled transmission/reception of the signal configured by the higher layer. When the dynamic flexible slots or symbols are divided into dynamic downlink/uplink/flexible subbands, a gap for DL/UL switching may be required between the downlink symbol and the uplink symbol. In this case, the gap may be a symbol unit. Referring to FIG. 26, a gap may be required between dynamic downlink symbols and a dynamic uplink subband. Furthermore, a gap may be required between a dynamic downlink subband and dynamic uplink symbols. A base station may configure the number of symbols for the gaps to the UE. Alternatively, the number of symbols for the gaps may be predefined, and the UE may use the predefined number of symbols for the gaps.

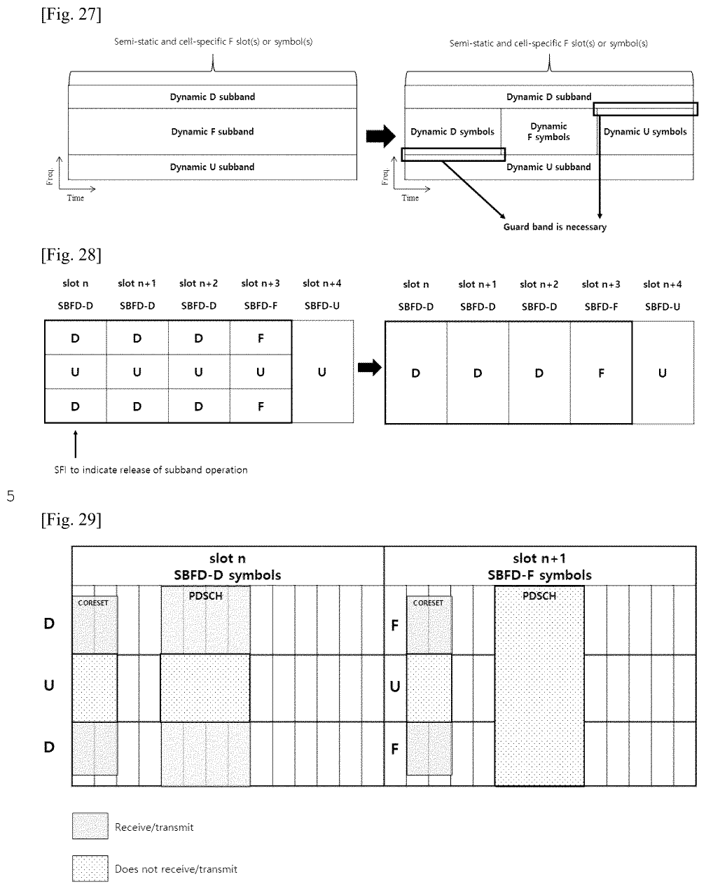

iii) The UE may apply a dynamic SFI to a flexible subband indicated by a dynamic subband format. Referring to FIG. 27, the UE may determine dynamic downlink/uplink/flexible subbands by applying an indicated dynamic subband format to a semi-statically configured cell-specific flexible slot or symbol. The UE may determine dynamic downlink/uplink/flexible slot(s) or symbol(s) by applying an indicated dynamic SFI to the dynamic flexible subband determined based on the dynamic subband format indication. Transmission/reception of a signal configured by the higher layer (e.g., PDSCH reception, CSI-RS reception, PUCCH transmission, PUSCH transmission, PRACH transmission, or SRS transmission) may be canceled by the dynamic subband format indication. However, when a specific format is again indicated by a dynamic SFI, the UE may perform the canceled transmission/reception of the signal configured by the higher layer. When the dynamic flexible subband is divided into dynamic downlink/uplink/flexible symbols, guard bands may be required between RBs of different subband types. Referring to FIG. 27, a guard band may be required between a dynamic downlink slot or symbol and a dynamic uplink subband. A guard band may be required between a dynamic uplink slot or symbol and a dynamic downlink subband. The base station may configure the number of RBs for guard bands to the UE. Alternatively, the number of RBs for the guard bands may be predefined, and the UE may use the predefined number of RBs for the guard bands.

### Overwriting Rule for Slot Format

As methods by which a base station informs a UE of slot format information, there may be 1) a method using a semi-static slot format, and 2) a method using a dynamic slot format based on DCI format 2_0 of GC-PDCCH. The semi-static slot format may be slot format information that the UE configures by receiving an RRC signal or SIB1, and the dynamic slot format based on DCI format 2_0 of the GC-PDCCH may be slot format information indicated by an L1 signal.

When the UE receives semi-static slot format information through the RRC signal and dynamic subband format information through the L1 signal, the UE should determine whether symbols in a slot are downlink symbols, uplink symbols, or flexible symbols, and the UE's operation should be defined based on the determined symbols. When a downlink symbol and an uplink symbol are configured semi-statically, no other type of slot or symbol may be indicated through the dynamic slot format based on DCI format 2_0 of the GC-PDCCH. However, a semi-statically configured flexible symbol may be indicated as a downlink symbol, an uplink symbol, or a flexible symbol based on DCI format 2_0 of the GC-PDCCH. Hereinafter, a UE operation for the semi-statically configured flexible symbol will be described. Specifically, hereinafter, a description will be made of a UE operation when a cell-specific/UE-specific flexible symbol semi-statically configured to the UE or a semi-static slot format is not configured for the UE.

### i) When a UE is not Configured to Monitor DCI Format 2_0 of GC-PDCCH

For semi-statically configured cell-specific/UE-specific flexible symbols, or for symbols not configured in a semi-static slot format, when the UE is not configured to periodically monitor a CORESET for receiving DCI format 2_0 of GC-PDCCH, operations performed by the UE are as follows.

When the UE receives, from the base station, a DCI format instructing the UE to receive PDSCH or CSI-RS, the UE may receive the PDSCH or the CSI-RS in a symbol set indicated by the DCI format.

When the UE receives, from the base station, a DCI format, RAR UL grant, fallbackRAR UL grant, or successRAR that instructs the UE to transmit PUSCH, PUCCH, PRACH, or SRS, the UE may transmit the PUSCH, the PUCCH, the PRACH, or the SRS in the symbol set indicated by the DCI format.

When the UE is configured by the higher layer to receive PDSCH or CSI-RS in a symbol set in a slot, the UE may not receive the PDSCH or the CSI-RS in the symbol set in the slot.

When the UE is configured by the higher layer to transmit PUSCH, PUCCH, PRACH, or SRS in a symbol set in a slot, the UE may not transmit the PUSCH, the PUCCH, the PRACH, or the SRS in symbol set in the slot.

### ii) When the UE is Configured to Monitor DCI Format 2_0 of GC-PDDCH, and Detects DCI Format 2_0.

For a cell-specific/UE-specific flexible symbol that is semi-statically configured for the UE, or for a symbol in which a semi-static slot format is not configured for the UE, when the UE is configured to periodically monitor a CORESET for receiving DCI format 2_0 of GC-PDCCH and when the UE detects DCI format 2_0 that indicates a slot format with a slot format value other than 255, operations performed by the UE are as follows.

When the UE is configured to monitor PDCCH in one or more symbols of a specific symbol set in a CORESET, the UE may receive the PDCCH in the CORESET only if slot format information included in DCI format 2_0 configures the one or more symbols as downlink symbols.

When the UE detects a DCI format instructing the UE to receive PDSCH or CSI-RS through a flexible symbol in a slot that is configured based on DCI format 2_0, the UE may receive the PDSCH or the CSI-RS through the configured flexible symbol in the slot.

When the UE detects a DCI format, RAR UL grant, fallbackRAR UL grant, or successRAR that indicates, to the UE, transmission of PUSCH, PUCCH, PRACH, or SRS through a flexible symbol in a sloth configured based on DCI format 2_0, the UE may transmit the PUSCH, the PUCCH, the PRACH, or the SRS through the configured flexible symbol in the slot.

When the UE has not detected a DCI format that indicates, to the UE, reception of PDSCH or CSI-RS through a flexible symbol in a slot configured based on DCI format 2_0, the UE may not receive the PDSCH or the CSI-RS through the configured flexible symbol in the slot. In addition, when the UE has not detected a DCI format, RAR UL grant, fallbackRAR UL grant, or successRAR, which instruct the UE to transmit PUSCH, PUCCH, PRACH, or SRS through a flexible symbol in a slot configured based on DCI format 2_0, the UE may not transmit the PUSCH, the PUCCH, the PRACH, or the SRS through the flexible symbol in the slot.

When the UE is configured by the higher layer to receive PDSCH or CSI-RS for a symbol set in a slot, the UE may receive the PDSCH or the CSI-RS from the symbol set only if slot format information in DCI format 2_0 indicates the symbol set as downlink symbols.

When the UE is configured by the higher layer to transmit PUCCH, PUSCH, or PRACH for a symbol set in a slot, the UE may transmit the PUCCH, the PUSCH, or the PRACH from the symbol set only if slot format information in DCI format 2_0 indicates the symbol set as uplink symbols.

When the UE is configured by the higher layer to transmit SRS for a symbol set in a slot, the UE may transmit the SRS from the symbol set only if slot format information in DCI format 2_0 indicates the symbol set as uplink symbols.

In relation to a symbol set in a slot, when slot format information in DCI format 2_0 indicates the symbol set as downlink symbols, the UE may not expect to detect a DCI format, RAR UL grant, fallbackRAR UL grant, or successRAR, which instructs the UE to transmit PUSCH, PUCCH, PRACH, or SRS in one or more symbols in the symbol set.

When a symbol set in a slot includes a symbol in which repeated transmission of PUSCH, activated by a UL Type 2 grant PDCCH (see TS 38.213 10.2), is performed, the UE may not expect that slot format information in DCI format 2_0 will indicate symbols in a symbol set as downlink symbols or flexible symbols.

When slot format information in DCI format 2_0 indicates that symbols of a symbol set in a slot are uplink symbols, the UE may not expect to detect a DCI format instructing the UE to receive PDSCH or CSI-RS in one or more symbols in the symbol set.

iii) When a UE is Configured to Monitor DCI Format 2_0 of GC-PDDCH, but does not Detect DCI Format 2_0.

When the UE has been configured to periodically monitor a CORESET for receiving DCI format 2_0 of the GC-PDCCH, for cell-specific/UE-specific flexible symbols semi-statically configured for the UE or for a symbol in which a semi-static slot format is not configured for the UE, but the UE fails to detect the DCI format 2_0 that indicates the slot format, the UE's operations are as follows.

When the UE receives a DCI format instructing the UE to receive PDSCH or CSI-RS, the UE may receive the PDSCH or the CSI-RS in a symbol set in a slot.

When the UE receives a DCI format, RAR UL grant, fallbackRAR UL grant, or successRAR, which instructs the UE to transmit PUSCH, PUCCH, PRACH, or SRS, the UE may transmit the PUSCH, the PUCCH, the PRACH, or the SRS in a symbol set in a slot.

Even when the UE is configured by a higher layer to receive PDSCH or CSI-RS in a symbol set in a slot, the UE may not receive the PDSCH or the CSI-RS in the symbol set.

The UE may be configured by a higher layer to transmit SRS, PUCCH, PUSCH, or PRACH on a symbol set in a slot. In this case, when a symbol in which the UE is configured to transmit the SRS, the PUCCH, the PUSCH, or the PRACH is a symbol which is after Tproc,2 from the last symbol of a CORESET in which the UE is configured to monitor PDCCH based on DCI format 2_0, the UE may not transmit the SRS, the PUCCH, the PUSCH, or the PRACH in a slot configured by a higher layer, or may not transmit the SRS, the PUCCH, the PUSCH, or the PRACH in a symbol in a slot that is configured for transmission of the SRS, the PUCCH, the PUSCH, or the PRACH.

The UE may be configured by a higher layer to transmit SRS, PUCCH, PUSCH, or PRACH in a symbol set in a slot. In this case, when a symbol in which the UE is configured to transmit the SRS, the PUCCH, the PUSCH, or the PRACH is a symbol which is before Tproc,2 from the last symbol of a CORESET in which the UE is configured to monitor PDCCH based on DCI format 2_0, the UE may not transmit the SRS, the PUCCH, the PUSCH, or the PRACH through the symbols of the symbol set in the slot.

When the UE does not detect DCI format 2_0 indicating that a symbol set in a slot is uplink symbols and the UE does not detect a DCI format instructing the UE to transmit SRS, PUSCH, PUCCH, or PRACH in the symbol set, the UE may assume that a flexible symbol in a CORESET configured to the UE for PDCCH monitoring is a downlink symbol.

### Overwriting Rule for Subband Format

As methods by which a base station informs a UE of subband format information, there may be 1) a method using a semi-static subband format, and 2) a method using a dynamic subband format based on DCI format 2_0 of GC-PDCCH or a new DCI format 2_x of GC-PDCCH. The UE may receive semi-static subband format information through an RRC signal and dynamic subband format information through an L1 signal to determine the type of subband. That is, the UE may determine whether RBs of the subband are downlink RBs, uplink RBs, or flexible RBs based on the semi-static subband format information and the dynamic subband format information, and may perform operations based on the determined RBs.

According to an embodiment of the present disclosure, a semi-statically configured downlink subband and a semi-statically configured uplink subband may not be indicated to the UE as a different type of subband or as a flexible subband through DCI format 2_0 of GC-PDCCH or the new DCI format 2_x of GC-PDCCH. However, a semi-statically configured flexible subband may be indicated to the UE as a downlink subband, an uplink subband, or a flexible subband through DCI format 2_0 or the new DCI format 2_x of GC-PDCCH. Hereinafter, operations performed by a UE regarding a semi-statically configured flexible subband will be described. Specifically, the description will be made of operations that the UE performs when a semi-statically configured cell-specific flexible subband or a semi-static subband format is not configured for the UE.

### i) When the UE is not Configured to Monitor DCI Format 2_0 of GC-PDCCH or a New DCI Format 2_x of GC-PDCCH

There may be a cell-specific flexible RB semi-statically configured for the UE, or an RB in which a semi-static subband format is not configured for the UE. In this case, when the UE is not configured to periodically monitor a CORESET for reception using DCI format 2_0 of GC-PDCCH or the new DCI format 2_x of GC-PDCCH, operations performed by the UE are as follows.

When the UE detects (receives) a DCI format indicating whether to receive PDSCH or CSI-RS, the UE may receive the PDSCH or the CSI-RS in an RB set of a semi-statically configured cell-specific flexible subband. In addition, when the UE detects (receives) a DCI format indicating whether to receive PDSCH or CSI-RS, the UE may receive the PDSCH or the CSI-RS in all RBs of symbols in a slot in which

DCI has been received, provided that a semi-static subband format is not configured for the UE.

When the UE receives a DCI format, RAR UL grant, fallbackRAR UL grant, or successRAR that indicates whether to transmit a PUSCH, PUCCH, PRACH, or SRS, the UE may transmit the PUSCH, the PUCCH, the PRACH, or the SRS in an RB set of a corresponding subband.

When the UE is configured by a higher layer to receive PDSCH or CSI-RS in an RB set of a specific subband, the UE may not receive the PDSCH or the CSI-RS in the RB set of the subband.

When the UE is configured by a higher layer to transmit PUSCH, PUCCH, PRACH, or SRS in an RB set of a specific subband, the UE may not transmit the PUSCH, the PUCCH, the PRACH, or the SRS in the RB set of the subband.

### ii) When the UE is Configured to Monitor DCI Format 2_0 of GC-PDDCH or a New DCI Format 2_x of GC-PDCCH, and the UE Detects DCI Format 2_0 or the New DCI Format 2_x of GC-PDCCH

There may be a cell-specific flexible RB semi-statically configured for the UE, or an RB in which a semi-static subband format is not configured for the UE. In this case, when the UE is configured to periodically monitor a CORESET for reception using DCI format 2_0 of GC-PDCCH or the new DCI format 2_x of GC-PDCCH and the UE detects DCI format 2_0 of GC-PDCCH or the new DCI format 2_x of GC-PDCCH, including subband format information, operations performed by the UE are as follows.

When one or more RBs in an RB set are RBs in a CORESET configured to the UE for PDCCH monitoring, the UE may receive the PDCCH in the CORESET only if subband format information of DCI format 2_0 of GC-PDCCH or the new DCI format 2_x of GC-PDCCH indicates the one or more RBs as downlink RBs.

When the subband format information of DCI format 2_0 of GC-PDCCH or the new DCI format 2_x of GC-PDCCH indicates that one or more RBs in an RB set are flexible RBs, and when the UE detects a DCI format instructing the UE to receive PDSCH or CSI-RS in the RB set including the indicated flexible RBs, the UE may receive the PDSCH or the CSI-RS in the RB set.

When the subband format information of DCI format 2_0 of GC-PDCCH or the new DCI format 2_x of GC-PDCCH indicates an RB set in a subband as flexible RBs, and when the UE detects a DCI format, RAR UL grant, fallbackRAR UL grant, or successRAR, which instructs the UE to transmit PUSCH, PUCCH, PRACH, or SRS, in the RB set in the subband, the UE may transmit the PUSCH, the PUCCH, the PRACH, or the SRS in the RB set in the subband.

The subband format information of DCI format 2_0 of GC-PDCCH or the new DCI format 2_x of GC-PDCCH indicates an RB set in a subband as flexible RBs, and the UE may not detect a DCI format instructing the UE to receive PDSCH or CSI-RS in the RB set in the subband, or the UE may not detect a DCI format, RAR UL grant, fallbackRAR UL grant, or successRAR, which instructs the UE to transmit PUSCH, PUCCH, PRACH, or SRS in the RB set in the subband. In such cases, the UE may not receive the PDSCH or the CSI-RS in the RB set in the subband. The UE may also not transmit the PUSCH, the PUCCH, the PRACH, or the SRS in the RB set in the subband.

When the UE is configured by a higher layer to receive PDSCH or CSI-RS in an RB set in a subband, the UE may receive the PDSCH or the CSI-RS in the RB set in the subband only if the subband format information of DCI format 2_0 of GC-PDCCH or the new DCI format 2_x of GC-PDCCH indicates the RB set in the subband as downlink RBs.

When the UE is configured by a higher layer to transmit SRS, PUCCH, PUSCH, or PRACH in an RB set in a subband, the UE may transmit the SRS, the PUCCH, the PUSCH, or the PRACH in the RB set in the subband only if the subband format information of DCI format 2_0 of GC-PDCCH or the new DCI format 2_x of GC-PDCCH indicates the RB set in the subband RBs as uplink RBs.

The subband format information of DCI format 2_0 of GC-PDCCH or the new DCI format 2_x of GC-PDCCH may indicate that an RB set in a subband is downlink RBs. In this case, the UE may not expect that a DCI format, RAR UL grant, fallbackRAR UL grant, or successRAR, which instructs the UE to transmit PUSCH, PUCCH, PRACH, or SRS in one or more RBs in the RB set in the subband will be detected.

When an RB set in a subband includes RBs in which repeated transmission of PUSCH activated by UL Type 2 grant PDCCH (see 3GPP TS38.213) is configured, the UE may not expect that the RB set in the subband will be indicated as downlink RBs or flexible RBs through the subband format information of DCI format 2_0 of GC-PDCCH or the new DCI format 2_x of GC-PDCCH.

The UE may not expect that an RB set in a subband will be indicated as uplink RBs through the subband format information of DCI format 2_0 of GC-PDCCH or the new DCI format 2_x of GC-PDCCH, and that a DCI format instructing the UE to receive PDSCH or CSI-RS in one or more RBs of the RB set in the subband will be detected.

iii) When the UE is Configured to Monitor DCI Format 2_0 of GC-PDCCH or a New DCI Format 2_x of GC-PDCCH, and does not Detect DCI Format 2 0 of GC-PDCCH or the New DCI Format 2_x of GC-PDCCH

For a semi-statically configured cell-specific flexible RB, or for an RB in which a semi-static subband format is not configured for the UE, the UE may be configured to periodically monitor a CORESET for the reception of DCI format 2_0 of GC-PDCCH or the new DCI format 2_x of GC-PDCCH. In this case, when the UE does not detect DCI format 2_0 of GC-PDCCH or the new DCI format 2_x of GC-PDCCH, operations performed by the UE are as follows.

When the UE receives a DCI format instructing the UE to receive PDSCH or CSI-RS, the UE may receive the PDSCH or the CSI-RS in an RB set of a semi-statically configured cell-specific flexible subband. In addition, when the UE detects (receives) a DCI format indicating whether to receive PDSCH or CSI-RS, the UE may receive the PDSCH or the CSI-RS in all RBs of symbols in a slot in which DCI has been received, provided that a semi-static subband format is not configured for the UE.

When the UE receives a DCI format, RAR UL grant, fallbackRAR UL grant, or successRAR, which instructs the UE to transmit PUSCH, PUCCH, PRACH, or SRS, the UE may transmit the PUSCH, the PUCCH, the PRACH, or the SRS in an RB set of the corresponding subband.

The UE may receive PDCCH as described in 3GPP TS38.213.

When the UE is configured by a higher layer to receive PDSCH or CSI-RS on an RB set in a subband from the higher layer, the UE may not receive the PDSCH or the CSI-RS in the RB set in the subband.

When the UE is configured by a higher layer to transmit SRS, PUCCH, PUSCH, or PRACH in an RB set in a subband, and when a configured symbol is a symbol which is after Tproc,2 from the last symbol of a CORESET in which the UE is configured to monitor PDCCH for DCI format 2_0 or the new DCI format 2_X, the UE may not transmit the SRS, the PUCCH, the PUSCH, or the PRACH in the subband.

When the UE is configured by a higher layer to transmit SRS, PUCCH, PUSCH, or PRACH in an RB set in a subband, and when a configured symbol is a symbol which is before Tproc,2 from the last symbol of a CORESET in which the UE is configured to monitor PDCCH for DCI format 2_0 or the new DCI format 2_X, the UE may not transmit the SRS, the PUCCH, the PUSCH, or the PRACH in the RB set in the subband.

When the UE does not detect DCI format 2_0 or the new DCI format 2_X indicating an RB set in a subband as flexible RBs or uplink RBs, and when the UE does not detect a DCI format instructing the UE to transmit SRS, PUSCH, PUCCH, or PRACH in the RB set, the UE may assume that a flexible RB of a CORESET configured to the UE for PDCCH monitoring is a downlink RB.

When a base station dynamically instructs the UE to release a subband operation, the base station may include a dynamic SFI in DCI format 2_0 of GC-PDCCH and transmit the same to the UE. The GC-PDCCH may be CRC-scrambled with SFI-RNTI for UEs receiving slot configuration information. Specifically, the UE may receive, from the base station, a dynamic SFI for a slot or a symbol in which multiple subbands are semi-statically configured in the frequency domain. Furthermore, based on the dynamic SFI, whether a symbol in the semi-statically configured slot is a downlink symbol, an uplink symbol, or a flexible symbol may be indicated to the UE. Alternatively, the UE may be instructed, through the dynamic SFI, to fall back to a TDD slot format pre-configured before receiving the dynamic SFI. For example, the dynamic SFI may instruct the UE to follow the configuration of a TDD UL/DL slot format with no subband configuration according to a TDD-UL/DL-common or TDD-UL/DL-dedicated configuration. Therefore, a slot or a symbol in which fallback is indicated by the SFI may not be configured as a subband for uplink transmission. Multiple subbands may be configured for the UE, and slots or symbols in which the multiple subbands are configured may include a downlink symbol (cell-specific or UE-specific) or a flexible symbol (cell-specific or UE-specific). When downlink symbols are configured to constitute multiple subbands, the downlink symbols may be described as SBFD downlink symbols, and when flexible symbols are configured to constitute multiple subbands, the flexible symbols may be described as SBFD flexible symbols.

When a slot or a symbol in which the subband operation is released is an SBFD downlink symbol, an SBFD symbol may be indicated to the UE as a downlink symbol by the base station through the dynamic SFI. That is, the UE may not expect that the SFD downlink symbol will be indicated as a different type of (i.e., flexible or uplink) symbol through the dynamic SFI. Alternatively, when the UE is instructed, through the dynamic SFI, to fall back to a TDD slot format before a subband configuration, the UE may assume that a slot or a symbol indicated by the dynamic SFI is the preconfigured TDD slot format, and the UE may not expect that the slot or symbol will be indicated as a type other than the preconfigured TDD slot or symbol type.

When a slot or a symbol in which the subband operation is released is an SBFD flexible symbol, the base station may indicate that the SBFD flexible symbol is one among a downlink symbol, an uplink symbol, and a flexible symbol. When the dynamic SFI indicates fallback to a TDD slot format before a subband configuration, the UE may assume that a slot or a symbol indicated by the dynamic SFI is a preconfigured TDD slot format, and the UE may not expect that the slot or the symbol will be indicated as a type other than the preconfigured TDD slot or symbol type.

FIG. 28 illustrates a method for indicating a fallback by a dynamic SFI according to an embodiment of the present disclosure.

Referring to FIG. 28, multiple subbands may be semi-statically configured for a UE in the frequency domain in slot n to slot n+3. Further, the UE may perform monitoring in slot n to receive a GC-PDCCH including a dynamic SFI. Thereafter, the UE may perform blind decoding in slot n to receive an SFI included in GC-PDCCH, and the SFI may include slot configuration information regarding four slots starting from slot n. In this case, since symbols in slot n to slot n+2 are SBFD downlink symbols, the SBFD downlink symbols may be indicated to the UE as downlink symbols through a dynamic SFI, and since symbols in slots n+3 are SBFD flexible symbols, the SBFD flexible symbols may be indicated to the UE as one of downlink symbols, uplink symbols, and flexible symbols through a dynamic SFI.

When the dynamic SFI indicates a fallback to a TDD slot format before a subband configuration, the UE may assume that the slots or symbols indicated by the dynamic SFI are a preconfigured TDD slot format. The symbols in slot n to slot n+2 may have been configured as downlink slots or symbols according to the predetermined TDD slot format before being configured as SBFD downlink symbols. The UE may assume that the SBFD downlink symbols in slot n to slot n+2 are downlink slots or symbols. The symbols in slot n+3 may have been configured as flexible symbols according to the preconfigured TDD slot format before being configured as SBFD flexible symbols. The UE may assume that the SBFD flexible symbols in slot n+3 are flexible slots or symbols.

### UE Behavior w.r.t. the SFI

There may be a case where a UE is configured to monitor the reception of a GC-PDCCH including an SFI by a base station, and the UE is instructed to succeed in the GC-PDCCH reception and release a subband operation. In this case, when a target to be released is an SBFD downlink symbol, the SBFD symbol may be indicated as a downlink symbol, and when a target to be released is an SBFD flexible symbol, the SBFD flexible symbol may be indicated as one of a downlink symbol, an uplink symbol, and a flexible symbol. Alternatively, the UE may assume the target to be released, based on the preconfigured TDD slot format. Hereinafter, a description will be made of the configuration of a GC-PDCCH including an SFI and UE operation based on whether the GC-PDCCH including the SFI is detected.

### i) When the UE is not Configured to Monitor DCI Format 2_0 of GC-PDCCH

When the UE is not configured to periodically monitor a CORESET for receiving GC-PDCCH for DCI format 2_0 with respect to a SBFD-downlink symbol or SBFD-flexible symbol semi-statically configured for the UE, UE operations are as follows.

When the UE receives a DCI format instructing the UE to receive PDSCH or CSI-RS, the UE may receive the PDSCH or the CSI-RS in a symbol set in a slot indicated by the DCI format.

When the UE receives a DCI format, RAR UL grant, fallbackRAR UL grant, or successRAR that indicates the transmission of PUSCH, PUCCH, PRACH, or SRS, the UE may transmit the PUSCH, the PUCCH, the PRACH, or the SRS in a symbol set in a slot indicated by the DCI format, RAR UL grant, fallbackRAR UL grant, or successRAR.

When the UE is configured by a higher layer to receive PDSCH or CSI-RS in a symbol set in a downlink subband or a flexible subband of a slot, the UE may receive the PDSCH or the CSI-RS in a symbol set in a configured slot.

When the UE is configured by a higher layer to transmit PUSCH, PUCCH, PRACH, or SRS in a symbol set in an uplink subband or a flexible subband of a slot, the UE may transmit the PUSCH, the PUCCH, the PRACH, or the SRS in the symbol set of the configured slot.

### ii) When the UE is Configured to Monitor DCI Format 2_0 of GC-PDDCH and the UE Detects DCI Format 2_0

When the UE is configured to periodically monitor a CORESET for reception of DCI format 2_0 of GC-PDCCH in a semi-statically configured SBFD-downlink symbol or SBFD-flexible symbol, and when the UE detects DCI format 2_0 indicating a slot format having a slot format value other than 255, UE operations are as follows.

When symbols in a CORESET configured to the UE for PDCCH monitoring include one or more symbols in a symbol set, the UE may receive PDCCH in the CORESET only if slot format information in DCI format 2_0 indicates one or more symbols as downlink symbols.

When slot format information in DCI format 2_0 indicates a symbol set in a slot as flexible symbols, and when the UE detects a DCI format indicating the reception of PDSCH or CSI-RS in the symbol set in the slot, the UE may receive the PDSCH or the CSI-RS in the symbol set in the slot.

When slot format information in DCI format 2_0 indicates a symbol set in a slot as flexible symbols and when the UE detects a DCI format, RAR UL grant, fallbackRAR UL grant, or successRAR that indicates the transmission of PUSCH, PUCCH, PRACH, or SRS in the symbol set in the slot, the UE may transmit the PUSCH, the PUCCH, the PRACH, or the SRS in the symbol set in the slot.

When slot format information in DCI format 2_0 indicates a symbol set in a slot as flexible symbols, and when the UE does not detect a DCI format indicating the reception of PDSCH or CSI-RS in the symbol set in the slot or the UE does not detect a DCI format, RAR UL grant, fallbackRAR UL grant, or successRAR that indicates the transmission of PUSCH, PUCCH, PRACH, or SRS in the symbol set in the slot, the UE may neither receive a downlink nor transmit an uplink in the symbol set in the slot.

When the UE is configured by a higher layer to receive PDSCH or CSI-RS in a symbol set in a slot, the UE may receive the PDSCH or the CSI-RS in the symbol set in the slot only if slot format information in DCI format 2_0 indicates the symbol set in the slot as a downlink.

When the UE is configured by a higher layer to transmit PUCCH, PUSCH, or PRACH in a symbol set in a slot, the UE may transmit the PUCCH, the PUSCH, or the PRACH in the symbol set in the slot only if slot format information in DCI format 2_0 indicates the symbol set in the slot as an uplink.

When the UE is configured by a higher layer to transmit SRS in a symbol set in a slot, the UE may transmit the SRS in only a symbol of the symbol set in the slot which is indicated as an uplink symbol by slot format information in DCI format 2_0.

When slot format information in DCI format 2_0 indicates a symbol set in a slot as a downlink, the UE may not expect to detect a DCI format, RAR UL grant, fallbackRAR UL grant, or successRAR that indicates the transmission of PUSCH, PUCCH, PRACH, or SRS in one or more symbols of the symbol set in the slot.

When a symbol set in a slot includes symbols in which repeated transmission of PUSCH activated by UL Type 2 grant PDCCH is performed, the UE may not expect slot format information in DCI format 2_0 will indicate the symbol set as downlink symbols or flexible symbols.

When slot format information in DCI format 2_0 indicates a symbol set in a slot as an uplink, the UE may not expect that the UE will detect a DCI format indicating the reception of PDSCH or CSI-RS in one or more symbols of the symbol set in the slot.

iii) When the UE is Configured to Monitor DCI Format 2_0 of GC-PDDCH and the UE does not Detect DCI Format 2_0

When the UE is configured to periodically monitor a CORESET for reception of DCI format 2_0 of GC-PDCCH in a semi-statically configured SBFD-downlink symbol or SBFD-flexible symbol, but when the UE does not detect DCI format 2_0, UE operations are as follows.

When the UE receives a DCI format indicating the reception of PDSCH or CSI-RS, the UE may receive the PDSCH or the CSI-RS in a symbol set of a slot indicated by the DCI format.

When the UE receives a DCI format, RAR UL grant, fallbackRAR UL grant, or successRAR that indicates the transmission of PUSCH, PUCCH, PRACH, or SRS, the UE may transmit the PUSCH, the PUCCH, the PRACH, or the SRS in a symbol set of an indicated slot.

The UE may receive PDCCH in a symbol set in a downlink subband or a flexible subband. That is, the UE may receive PDCCH by monitoring the PDCCH in a configured CORESET in a symbol set in a downlink subband. When RBs in the configured CORESET are included in an uplink subband or a guard band, the UE may not monitor PDCCH in the symbol set.

When the reception of PDSCH or CSI-RS in a symbol set within a downlink subband of a slot is configured by a higher layer, the UE may receive the PDSCH or the CSI-RS in the symbol set of the slot.

When transmission of SRS, PUCCH, PUSCH, or PRACH in a symbol set within a downlink subband of a slot is configured by a higher layer, the UE may not transmit the SRS, the PUCCH, the PUSCH, or the PRACH in the symbol set of the slot.

When reception of PDSCH or CSI-RS in a symbol set in a flexible subband or an uplink subband of a slot is configured by a higher layer, the UE may not receive the PDSCH or the CSI-RS in the symbol set of the slot.

When transmission of SRS, PUCCH, PUSCH, or PRACH in a symbol set in a flexible subband or an uplink subband of a slot is configured by a higher layer, the UE may transmit the SRS, the PUCCH, the PUSCH, or the PRACH in the symbol set of the slot.

There may be a case where the transmission of SRS, PUCCH, PUSCH, or PRACH in a symbol set of a slot is configured by a higher layer. In this case, when a symbol in which the transmission is configured is a symbol which is after Tproc,2 from the last symbol of a CORESET configured for monitoring of PDCCH for DCI format 2_0, the UE may not transmit the PUCCH, the PUSCH, or the PRACH in the slot. Furthermore, the UE may not transmit the SRS in the symbol set of the slot.

There may be a case where the transmission of SRS, PUCCH, PUSCH, or PRACH in a symbol set of a slot is configured by a higher layer. In this case, when a symbol in which transmission is configured is the symbol which is before Tproc,2 from the last symbol of a CORESET configured for monitoring of PDCCH for DCI format 2_0, the UE may not transmit the SRS, the PUCCH, the PUSCH, or the PRACH in the symbol set of the slot.

When the UE does not detect a DCI format 2_0 indicating a symbol set in a slot as flexible or uplink and does not detect a DCI format instructing the UE to transmit SRS, PUSCH, PUCCH, or PRACH in the symbol set, the UE may assume that a flexible symbol in a CORESET configured to the UE for PDCCH monitoring is a downlink symbol.

FIGS. 29 to 33 illustrate symbols in a slot within a subband according to an embodiment of the present.

Referring to FIG. 29, slot n may include SBFD downlink symbols, and slot n+1 may include SBFD flexible symbols. A UE may be configured to periodically monitor a CORESET for the reception of DCI format 2_0 of GC-PDCCH in slots n and n+1, but the UE may not detect an SFI.

For example, the UE may monitor a CORESET in symbols, in which the UE is configured to monitor the CORESET in slot n and which are not in an uplink subband (i.e., symbols in a downlink subband), and receive PDCCH. When the UE is configured by a higher layer to receive PDSCH, the UE may receive PDSCH in symbols which are not in the uplink subband (i.e., symbols within the downlink subband).

For example, the UE may be configured to monitor CORESETs positioned in the downlink subband in slot n. That is, the UE may monitor PRBs and symbols in the frequency domain excluding the uplink subband among the CORESETs (i.e., CORESETs positioned in symbols in the downlink subband), and receive PDCCH. When the UE is configured by a higher layer to receive PDSCH, the UE may receive the PDSCH in symbols which are not in the uplink subband (i.e., symbols in the downlink subband).

For example, the UE may monitor a CORESET in symbols in which the UE is configured to monitor the CORESET in slot n+1 and which are not in the uplink subband (i.e., symbols in the flexible subband), and receive PDCCH. When the UE is configured by a higher layer to receive PDSCH, the UE may not receive the PDSCH in the symbols in which the UE is configured to receive the PDSCH.

For example, the UE may be configured to monitor CORESETs positioned in the flexible subband in slot n+1. That is, the UE may monitor PRBs and symbols in the frequency domain excluding the uplink subband among the CORESETs (i.e., CORESETs positioned in symbols in the flexible subband), and receive PDCCH. When the UE is configured by a higher layer to receive PDSCH, the UE may not receive the PDSCH in symbols in which the UE is configured to receive the PDSCH.

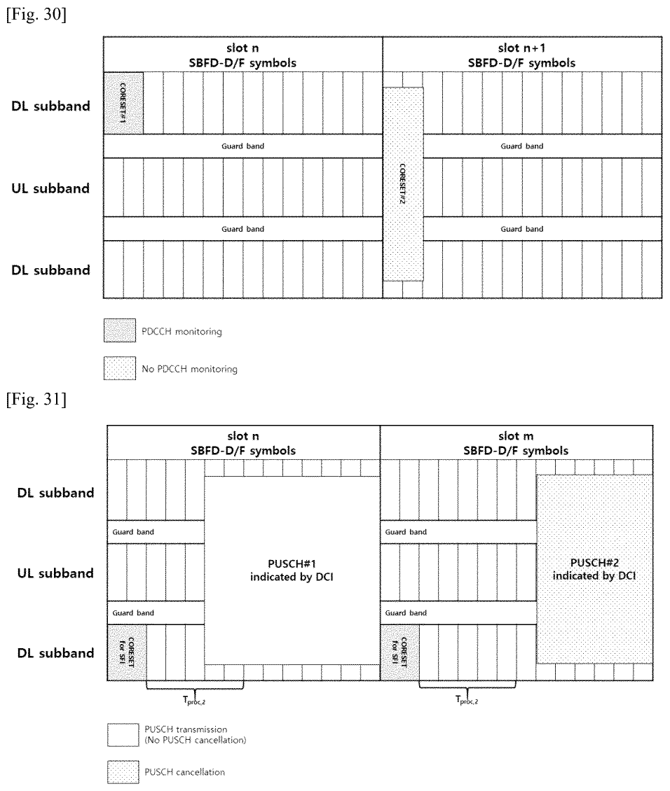

Referring to FIG. 30, slot n may include SBFD-downlink or SBFD-flexible symbols. Slot n+1 may include SBFD-downlink or SBFD-flexible symbols. Although a UE is configured to periodically monitor a CORESET for the reception of DCI format 2_0 of GC-PDCCH in slot n+1, the UE may not detect DCI format 2_0 including an SFI. The following describes UE operation for slot n+1 when the SFI is unknown because the UE does not detect DCI format 2_0.

For example, the UE may receive PDCCH by monitoring a candidate PDCCH in symbols which are not in an uplink subband and a guard band (i.e., symbols which include a CORESET positioned within a downlink subband), among symbols which include a CORESET in which the UE is configured to monitor the candidate PDCCH in slot n.

For example, when a CORESET is configured in slot n+1 with a frequency domain and symbols including the uplink subband and a guard band, and when the UE is configured to monitor a candidate PDCCH in the CORESET, the UE may not monitor the candidate PDCCH in the configured CORESET in a symbol set in slot n+1.

For the SBFD downlink symbols or the SBFD flexible symbols, slot format information may be always indicated as a downlink symbol to the UE. The UE may determine that the SBFD downlink symbols or the SBFD flexible symbols are resources for downlink reception. The following describes UE operations depending on the configuration and detection of DCI format 2_0 including an SFI, i.e. GC-PDCCH.

### i) When the UE is not Configured to Monitor DCI Format 2_0 of GC-PDCCH

When the UE is not configured to periodically monitor a CORESET for the reception of DCI format 2_0 of GC-PDCCH in a semi-statically configured SBFD downlink symbol or SBFD flexible symbol, UE operations are as follows.

When the UE receives a DCI format indicating the reception of PDSCH or CSI-RS, the UE may receive the PDSCH or the CSI-RS in a symbol set of an indicated slot.

When the UE receives a DCI format, RAR UL grant, fallbackRAR UL grant, or successRAR that indicates the transmission of PUSCH, PUCCH, PRACH, or SRS, the UE may transmit the PUSCH, the PUCCH, the PRACH, or the SRS in a symbol set of an indicated slot.

When the reception of PDSCH or CSI-RS in a symbol set within a downlink subband of a slot is configured by a higher layer, the UE may receive the PDSCH or the CSI-RS in the symbol set in the slot.

When the reception of PUSCH, PUCCH, PRACH, or SRS in a symbol set in an uplink subband of a slot is configured by a higher layer, the UE may transmit the PUSCH, the PUCCH, the PRACH, or the SRS in the symbol set in the slot.

When the reception of PDSCH or CSI-RS in a symbol set including an uplink subband of a slot is configured by a higher layer, the UE may not receive the PDSCH or the CSI-RS in the symbol set of the slot.

When the transmission of PUSCH, PUCCH, PRACH, or SRS in a symbol set within a downlink subband of a slot is configured by a higher layer, the UE may not transmit the PUSCH, the PUCCH, the PRACH, or the SRS in the symbol set in the slot.

### ii) When the UE is Configured to Monitor DCI Format 2_0 of GC-PDDCH and the UE Detects DCI Format 2_0

When the UE is configured to periodically monitor a CORESET for the reception of DCI format 2_0 of GC-PDCCH in a semi-statically configured SBFD downlink symbol or SBFD flexible symbol, and when the UE detects DCI format 2_0 indicating a slot format having a slot format value other than 255, UE operations are as follows.

When one or more symbols in a symbol set configured as semi-statically configured SBFD downlink symbols or SBFD flexible symbols are symbols within a CORESET in which PDCCH monitoring is performed, the UE may monitor PDCCH in the CORESET and receive the PDCCH, only if slot format information in DCI format 2_0 indicates all symbols occupied by the CORESET as downlink symbols.

When a symbol set in a slot, configured as semi-statically configured SBFD downlink symbols or SBFD-flexible symbols, is indicated as downlink symbols by slot format information in DCI format 2_0, and when the UE detects a DCI format indicating the reception of PDSCH or CSI-RS in the symbol set in the slot, the UE may receive the PDSCH or the CSI-RS in the symbol set in the slot.

The following describes operations that the UE performs when a symbol set in a slot, configured as semi-statically configured SBFD downlink symbols or SBFD flexible symbols, is indicated as downlink symbols by slot format information in DCI format 2_0, and when the UE detects a DCI format, RAR UL grant, fallbackRAR UL grant, or successRAR that indicates the transmission of PUSCH, PUCCH, PRACH, or SRS in the symbol set in the slot.

Based on Tproc,2, which is a PUSCH preparation time according to UE processing capability, the UE may perform the following operations.

When the UE does not indicate the capability of partialCancellation to a base station and when the first symbol, in which the transmission of PUCCH, PUSCH, or PRACH is indicated, is a symbol which is within Tproc,2 from the last symbol of a CORESET in which DCI format 2_0 has been detected, the UE may not expect that the transmission of PUCCH, PUSCH, or PRACH in a slot in which the CORESET has been detected will be canceled. That is, the UE may transmit the PUCCH, the PUSCH, or the PRACH in a slot in which the CORESET has been detected.

When the UE does not indicate the capability of partialCancellation to the base station, and when the first symbol, in which the transmission of PUCCH, PUSCH, or PRACH is indicated, is a symbol which is after Tproc,2 from the last symbol of a CORESET in which DCI format 2_0 has been detected, the UE may cancel the transmission of the PUCCH, the PUSCH, or the PRACH in a slot in which the CORESET has been detected.

When the UE indicates, to the base station, the capability of partialCancellation, and when symbols in which the transmission of PUCCH, PUSCH, or PRACH is indicated are symbols which are within Tproc,2 from the last symbol of a CORESET in which DCI format 2_0 has been detected, the UE may not expect that the transmission of the PUCCH, the PUSCH, or the PRACH will be canceled for the symbols in which the transmission is indicated. That is, the UE may transmit the PUCCH, the PUSCH, or the PRACH in the symbols in which the transmission is indicated.

When the UE indicates, to the base station, the capability of partialCancellation and when symbols in which transmission of PUCCH, PUSCH, or PRACH is indicated are symbols which are after Tproc,2 from the last symbol of a CORESET in which DCI format 2_0 has been detected, the UE may cancel the transmission of the PUCCH, the PUSCH, or the PRACH for the symbols in which the transmission is indicated.

When a symbol in which transmission of SRS is indicated is a symbol which is within Tproc,2 from the last symbol of a CORESET in which DCI format 2_0 has been detected, the UE may not expect that the transmission of the SRS will be canceled in the symbol in which the transmission is indicated. That is, the UE may transmit the SRS in the symbol in which the transmission is indicated.

When a symbol in which transmission of SRS is indicated is a symbol which is after Tproc,2 from the last symbol of a CORESET in which DCI format 2_0 has been detected, the UE may cancel the transmission of the SRS in the symbol in which the transmission is indicated.

When a semi-statically configured SBFD downlink symbol or SBFD-flexible symbol in a symbol set of a slot is indicated as a downlink symbol by slot format information in DCI format 2_0, the UE may not expect to detect a DCI format, RAR UL grant, fallbackRAR UL grant, or successRAR indicating the transmission of PUSCH, PUCCH, PRACH, or SRS in the symbol set of the slot.

When the reception of PDSCH or CSI-RS in a symbol configured as a semi-statically configured SBFD downlink symbol or SBFD-flexible symbol in a symbol set of a slot is configured by a higher layer, the UE may receive the PDSCH or the CSI-RS in the symbol set of the slot only if slot format information in DCI format 2_0 indicates the symbol set of the slot as a downlink.

When the transmission of PUCCH, PUSCH, or PRACH in a symbol configured as a semi-statically configured SBFD downlink symbol or SBFD flexible symbol in a symbol set of a slot is configured by a higher layer, the UE may perform operations to be described later, if slot format information in DCI format 2_0 in the symbol set of the slot indicates the symbol set of the slot as downlink symbols.

Based on Tproc,2, which is a PUSCH preparation time according to UE processing capability, the UE may perform the following operations.

When the UE does not indicate the capability of partialCancellation to the base station and when a symbol in which transmission of PUCCH, PUSCH, or PRACH is indicated is a symbol which is within Tproc,2 from the last symbol of a CORESET in which DCI format 2_0 has been detected, the UE may perform the transmission of PUCCH, PUSCH, or PRACH in a slot including the symbol in which the transmission is indicated.

When the UE does not indicate the capability of partialCancellation to the base station, and when a symbol in which transmission of PUCCH, PUSCH, or PRACH is indicated is a symbol which is after Tproc,2 from the last symbol of a CORESET in which DCI format 2_0 has been detected, the UE may cancel the transmission of the PUCCH, the PUSCH, or the PRACH in a slot including the symbol in which transmission is indicated.

When the UE indicates, to the base station, the capability of partialCancellation and when a symbol in which transmission of PUCCH, PUSCH, or PRACH is indicated is a symbol which is within Tproc,2 from the last symbol of a CORESET in which DCI format 2_0 has been detected, the UE may not expect that the transmission of the PUCCH, the PUSCH, or the PRACH will be canceled in the symbol in which the transmission is indicated. That is, the UE may transmit the PUCCH, the PUSCH, or the PRACH in the symbol in which the transmission is indicated.

When the UE indicates, to the base station, the capability of partialCancellation and when a symbol in which transmission of PUCCH, PUSCH, or PRACH is indicated is a symbol which is after Tproc,2 from the last symbol in a CORESET in which DCI format 2_0 has been detected, the UE may cancel the transmission of the PUCCH, the PUSCH, or the PRACH in the symbol in which the transmission is indicated.

When a symbol in which transmission of SRS is indicated is a symbol which is within Tproc,2 from the last symbol in a CORESET in which DCI format 2_0 has been detected, the UE may not expect that the SRS transmission will be canceled in the symbol in which the transmission is indicated. That is, the UE may transmit the SRS in the symbol in which the transmission is indicated.

When a symbol in which transmission of SRS is indicated is a symbol which is after Tproc,2 from the last symbol in a CORESET in which DCI format 2_0 has been detected, the UE may cancel the transmission of the SRS in the symbol in which the transmission is indicated.

Referring to FIG. 31, slot n may include SBFD downlink symbols or SBFD flexible symbols. Slot m may include SBFD downlink or SBFD flexible symbols. A UE may be configured to periodically monitor a CORESET for the reception of DCI format 2_0 of GC-PDCCH in slots n and m. A symbol set in a slot configured as semi-statically configured SBFD downlink symbols or SBFD flexible symbols may be indicated as a downlink by slot format information in DCI format 2_0. In addition, Tproc,2 for the UE may be 5 (symbols), and the UE may not indicate the capability of partialCancellation to a base station.

Referring to FIG. 31, there may be a case where the UE monitors, in a CORESET, PDCCH including DCI format 2_0 including an SFI in slot n to detect DCI format 2_0, and slot format information of the SFI indicates a downlink symbol. Within the interval Tproc,2 (5 symbols) from the last symbol in the CORESET, two symbols of PUSCH #1 (i.e., PUSCH with a length of 9 symbols) indicated by the DCI for uplink transmission may be included. Therefore, the UE may not expect that transmission of PUSCH #1 will be canceled. That is, the UE may transmit PUSCH #1 in slot n.

Referring to FIG. 31, there may be a case where the UE monitors, in a CORESET, PDCCH including DCI format 2_0 including an SFI in slot n and detects DCI format 2_0, and slot format information of the SFI indicates a downlink symbol. In this case, the UE may not expect that transmission of PUSCH #1 will be indicated by the base station through DCI in a symbol indicated as the downlink symbol.

Referring to FIG. 31, there may be a case where the UE monitors, in a CORESET, PDCCH including DCI format 2_0 including an SFI in slot m to detects DCI format 2_0, and slot format information of the SFI indicates a downlink symbol. Within the interval Tproc,2 (5 symbols) from the last symbol of the CORESET, two symbols of PUSCH #2 (i.e., PUSCH with a length of 6 symbols) indicated by DCI for uplink transmission may not be included. Therefore, the UE may cancel transmission of PUSCH #2.

Referring to FIG. 31, there may be a case where the UE monitors, in a CORESET, PDCCH including DCI format 2_0 including an SFI in slot m and detects DCI format 2_0, and slot format information of the SFI indicates a downlink symbol. In this case, the UE may not expect that the transmission of PUSCH #2 will be indicated by the base station through DCI in a symbol indicated as the downlink symbol.

iii) When the UE is Configured to Monitor DCI Format 2_0 of GC-PDDCH, and the UE does not Detect DCI Format 2_0

When periodic monitoring of a CORESET for the reception of DCI format 2_0 of GC-PDCCH is configured in a semi-statically configured SBFD downlink symbol or SBFD flexible symbol but the UE fails to detect DCI format 2_0, operations performed by the UE are as follows.

When the UE receives a DCI format instructing the UE to receive PDSCH or CSI-RS in a symbol set in a slot including semi-statically configured SBFD downlink symbols or SBFD flexible symbols, the UE may receive the PDSCH or the CSI-RS in the symbol set in the slot.

When the UE receives a DCI format, RAR UL grant, fallbackRAR UL grant, or successRAR, which indicates transmission of PUSCH, PUCCH, PRACH, or SRS, in a symbol set of a slot that is configured as semi-statically configured SBFD downlink symbols or SBFD flexible symbols, the UE may transmit the PUSCH, the PUCCH, the PRACH, or the SRS in the symbol set of the slot.

PDCCH may be received in a symbol within a downlink subband among a symbol set in a slot including semi-statically configured SBFD downlink symbols or SBFD flexible symbols. That is, the UE may monitor PDCCH and receive PDCCH only in a CORESET configured for symbols in the downlink subband. When RBs of the CORESET are included in an uplink subband or a guard band, the UE may not monitor the PDCCH in the symbol set.

When the UE is configured by a higher layer to receive PDSCH or CSI-RS in some symbols, which are within a downlink subband of a slot, among a symbol set in the slot including semi-statically configured SBFD downlink symbols or SBFD flexible symbols, the UE may receive the PDSCH or the CSI-RS in some symbols which are within the downlink subband of the slot.

When the UE is configured by a higher layer to transmit SRS, PUCCH, PUSCH, or PRACH in some symbols within a downlink subband of a slot, among a symbol set in the slot including semi-statically configured SBFD downlink symbols or SBFD flexible symbols, the UE may not transmit the SRS, the PUCCH, PUSCH, or the PRACH on some symbols within the downlink subband of the slot.

When the UE is configured by a higher layer to receive PDSCH or CSI-RS in some symbols, which are within an uplink subband of a slot, among a symbol set in the slot including semi-statically configured SBFD downlink symbols or SBFD flexible symbols, the UE may not receive the PDSCH or the CSI-RS in some symbols which are within the uplink subband of the slot.

Operations performed by the UE when the UE is configured by a higher layer to transmit SRS, PUCCH, PUSCH, or PRACH in some symbols, which are within an uplink subband of a slot, among a symbol set in the slot including semi-statically configured SBFD downlink symbols or SBFD flexible symbols, will be described later.

Based on Tproc,2, which is a PUSCH preparation time according to UE processing capability, the UE may perform the following operations.

When the UE does not indicate the capability of partialCancellation to the base station and when the first symbol in which transmission of PUCCH, PUSCH, or PRACH is indicated is a symbol which is within Tproc,2 from the last symbol of a CORESET in which DCI format 2_0 has been detected, the UE may not expect that the transmission of the PUCCH, the PUSCH, or the PRACH will be canceled in the symbol in which the transmission is indicated. That is, the UE may transmit the PUCCH, the PUSCH, or the PRACH in the symbol in which the transmission is indicated.

When the UE does not indicate the capability of partialCancellation to the base station and when the first symbol in which transmission of PUCCH, PUSCH, or PRACH is indicated is a symbol which is after Tproc,2 from the last symbol of a CORESET in which DCI format 2_0 has been detected, the UE may cancel the transmission of the PUCCH, the PUSCH, or the PRACH in a slot including the symbol in which the transmission is indicated.

When the UE indicates the capability of partialCancellation to the base station, and when the first symbol in which transmission of PUCCH, PUSCH, or PRACH is indicated is a symbol which is within Tproc,2 from the last symbol of the CORESET in which DCI format 2_0 has been detected, the UE may not expect that the transmission of the PUCCH, the PUSCH, or the PRACH will be canceled in the symbol in which the transmission is indicated. That is, the UE may transmit the PUCCH, the PUSCH, or the PRACH in the symbol in which the transmission is indicated.

When the UE indicates the capability of partialCancellation to the base station and when the first symbol in which transmission of PUCCH, PUSCH, or PRACH is indicated is a symbol which is after Tproc,2 from the last symbol of a CORESET in which DCI format 2_0 has been detected, the UE may cancel the transmission of the PUCCH, the PUSCH, or the PRACH in the symbol in which the transmission is indicated.

When a symbol in which transmission of SRS is indicated is a symbol which is within Tproc,2 from the last symbol in a CORESET in which DCI format 2_0 has been detected, the UE may not expect that the transmission of the SRS will be canceled in the symbol in which the transmission is indicated. That is, the UE may transmit the SRS in the symbol in which the transmission is indicated.

When a symbol in which transmission of SRS is indicated is a symbol which is after Tproc,2 from the last symbol in a CORESET in which DCI format 2_0 has been detected, the UE may cancel the transmission of the SRS in the symbol in which the transmission is indicated.

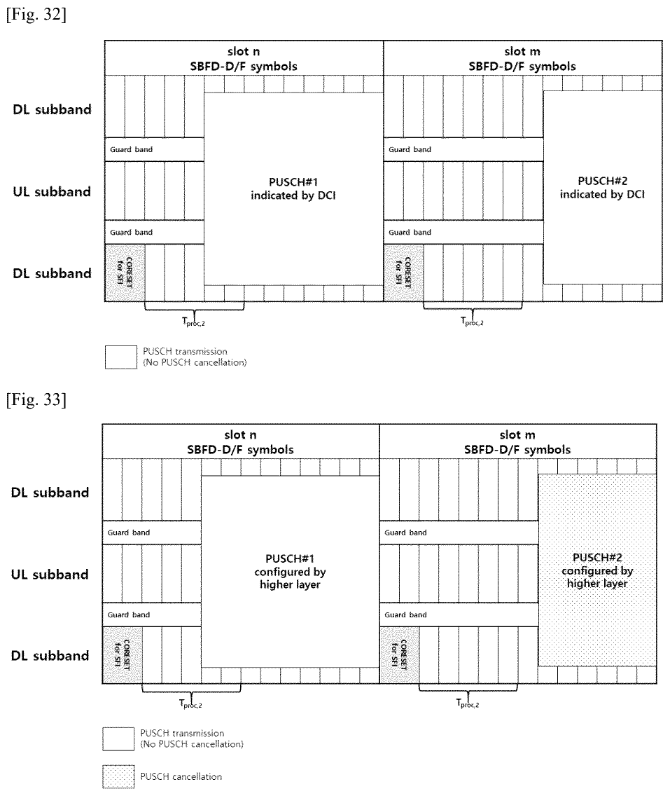

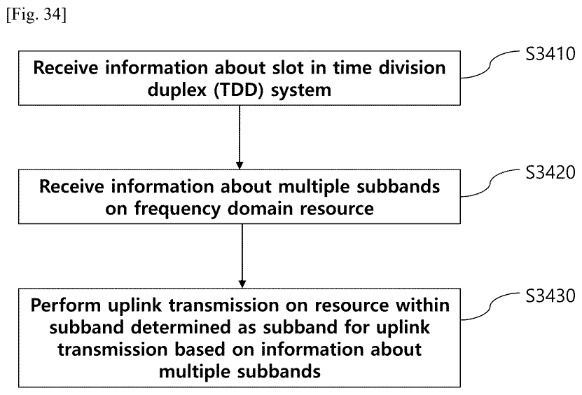

Referring to FIGS. 32 and 33, slot n may include SBFD downlink or SBFD flexible symbols. Slot m may include SBFD downlink or SBFD flexible symbols. A UE has been configured to periodically monitor a CORESET for the reception of DCI format 2_0 of GC-PDCCH in slot n and slot m, but the UE may not detect an SFI. Tproc,2 may be 5 symbols, and the UE may not indicate the capability of partialCancellation to the base station.

Referring to FIG. 32, the UE may be instructed by a base station to transmit PUSCH #1 and PUSCH #2 through DCI. When the UE receives a DCI format instructing the UE to transmit PUSCH #1 (i.e., PUSCH having a length of 9 symbols) in slot n, the UE may transmit PUSCH #1 in a symbol set of slot n. When the UE receives a DCI format instructing the UE to transmit PUSCH #2 (i.e., PUSCH having a length of 6 symbols) in slot m, the UE may transmit PUSCH #2 in a symbol set of slot m.

Referring to FIG. 33, the UE may be indicated by a higher layer to transmit PUSCH #1 (i.e., PUSCH having a length of 9 symbols) in slot n and PUSCH #2 (i.e., PUSCH having a length of 6 symbols) in slot m. Since two symbols for the transmission of PUSCH #1 are included in the interval of Tproc,2 (5 symbols) from the last symbol of a CORESET, the UE may not expect that the transmission of PUSCH #1 will be canceled. That is, the UE may perform the transmission of PUSCH #1 indicated through DCI in slot n. Since no symbols of PUSCH #2 are included in the interval Tproc,2 (5 symbols) from the last symbol of a CORESET, the UE may cancel the transmission of PUSCH #2 indicated through DCI.

Considering a dynamic SFI includes group-common information for a UE performing the in-cell subband operation described above and a UE not performing the in-cell subband operation, it is difficult to construct flexible slot format information. Hereinafter, a method to solve this problem will be described.

When the UE is instructed, by the base station through an SFI, to release a subband operation, the UE may receive information other than information about a specific symbol type. When one of slot formats 56-254 (i.e., reserved) in Table 4 above is configured through RRC, the UE may assume that the subband operation is released. In this case, the UE may assume that an SBFD downlink symbol is configured as a downlink symbol (cell-specific or UE-specific) and an SBFD flexible symbol is configured as a flexible symbol (cell-specific or UE-specific). When a UE receives slot format 56-254, a UE that does not perform subband behavior has no predefined operation. Therefore, a legacy UE and UEs capable of performing a subband operation may coexist on the same network, allowing for a more flexible configuration of slot format information.

FIG. 34 is a flowchart illustrating a method for configuring a subband according to an embodiment of the present disclosure.

The method for configuring a subband, as described above using FIGS. 1 to 33, will be described with reference to FIG. 34.

A UE may receive information about a slot in a time division duplex (TDD) system (S3410). The UE may receive information about multiple subbands on a frequency domain resource (S3420). The multiple subbands may be configured on a frequency domain resource within a predetermined time domain resource of the slot. The frequency domain resource may be included in the carrier bandwidth of the UE. The information about the slot may include information indicating the type of symbol in the slot. The information about the multiple subbands may include information related to a position of at least one of the multiple subbands in a frequency domain and information related to the type of the at least one subband. The UE may perform uplink transmission on a resource in a subband that is determined to be a subband for the uplink transmission, based on the information about the multiple subbands (S3430).

One subband among the multiple subbands may be determined as a subband for the uplink transmission based on the information about the multiple subbands.

The subband determined as a subband for the uplink transmission may include the lowest frequency band or the highest frequency band in the frequency domain resource.

When the multiple subbands are three or more, the subband determined as the subband for the uplink transmission may be positioned between two or more remaining subbands.

The information about the multiple subbands may include information about an index of the slot, the number of first RBs constituting a first type of subband, and the number of second RBs constituting a second type of subband. The first type of subband included in the multiple subbands may include as many RBs as the number of the first RBs, starting from the first RB in the frequency domain resource of the slot. The second type of subband included in the multiple subbands may include as many RBs as the number of the second RBs, starting from the last RB in the frequency domain resource of the slot.

The information about the multiple subbands may be applied to a slot which is determined as a downlink slot or a flexible slot based on the information about the slot.

The downlink slot may include a downlink symbol. The flexible slot may include at least one of a downlink symbol, an uplink symbol, and a flexible symbol. The downlink symbol may be a symbol available for downlink reception, the uplink symbol may be a symbol available for uplink transmission, and the flexible symbol may be a symbol available for the downlink reception or for the uplink transmission.

The information about the slot and the information about the multiple subbands may be configured semi-statically.

The UE may receive dynamic signaling that indicates information deactivating the multiple subbands and the type of symbols in the slot. When a slot in which a subband deactivated based on the deactivating information is configured is the downlink slot, the type of symbols in the slot may be indicated as downlink symbols. When a slot in which a subband deactivated based on the deactivating information is configured is the flexible slot, the type of symbols in the slot may be indicated as one of downlink symbols, uplink symbols, and flexible symbols. The downlink symbol may be a symbol available for downlink reception, the uplink symbol may be a symbol available for uplink transmission, and the flexible symbol may be a symbol available for the downlink reception or for the uplink transmission.

The dynamic signaling may include information indicating that the type of symbol in the slot should be configured as a preconfigured type.

A UE performing the method described with reference to FIG. 34 may be the UE described in FIG. 11. Specifically, the UE may include a communication module configured to transmit and receive wireless signals, and a processor configured to control the communication module. In this case, the processor of the UE may perform the method described in the present specification.

Furthermore, a base station performing the method described in the present specification may include a communication module configured to transmit and receive wireless signals, and a processor configured to control the communication module. In this case, the base station may be the base station described in FIG. 11. The processor of the base station may perform the method described in the present specification.

The method and system of the present disclosure are described in relation to specific embodiments, but configuration elements, a part of or the entirety of operations of the present disclosure may be implemented using a computer system having a general-purpose hardware architecture.

The foregoing descriptions of the present disclosure are for illustration purposes, and those skilled in the art, to which the present disclosure belongs, will be able to understand that modification to other specific forms can be easily achieved without changing the technical spirit or essential features of the present disclosure. Therefore, it should be understood that the embodiments described above are illustrative and are not restrictive in all respects. For example, each element described as one type may be implemented in a distributed manner, and similarly, elements described as being distributed may also be implemented in a combined form.

The scope of the present disclosure is indicated by claims to be described hereinafter rather than the detailed description, and all changes or modifications derived from the meaning and scope of the claims and their equivalent concepts should be interpreted as being included in the scope of the present disclosure.

1. A UE in a wireless communication system, the UE comprising:
a transceiver; and
a processor configured to control the transceiver,
wherein the processor is configured to:
receive information about a slot in a time division duplex (TDD) system,
receive information about multiple subbands on a frequency domain resource,
wherein the multiple subbands being configured on a frequency domain resource within a predetermined time domain resource of the slot,
wherein the frequency domain resource being included within a carrier bandwidth of the UE,
wherein the information about the slot comprising information indicating a type of symbol in the slot,
wherein the information about the multiple subbands comprising information related to a position of at least one of the multiple subbands in a frequency domain and information related to a type of the at least one subband, and
perform uplink transmission on a resource within a subband determined as a subband for the uplink transmission based on the information about the multiple subbands.

2. The UE of claim 1, wherein one subband, among the multiple subbands, is determined as the subband for the uplink transmission based on the information about the multiple subbands.

3. The UE of claim 2, wherein the subband determined as the subband for uplink transmission comprises a lowest frequency band or a highest frequency band on the frequency domain resource.

4. The UE of claim 2, wherein when the multiple subbands are three or more, the subband determined as the subband for the uplink transmission is positioned between two or more remaining subbands.

5. The UE of claim 1, wherein the information about the multiple subbands comprises information about an index of the slot, the number of first RBs constituting a first type of subband, and the number of second RBs constituting a second type of subband,
wherein the first type of subband comprises as many RBs as the number of the first RBs, starting from a first RB in the frequency domain resource of the slot, and
wherein the second type of subband comprises as many RBs as the number of the second RBs, starting from a last RB in the frequency domain resource of the slot.

6. The UE of claim 1, wherein the information about the multiple subbands is applied to a slot that is determined as a downlink slot or a flexible slot based on the information about the slot.

7. The UE of claim 6, wherein the downlink slot comprises a downlink symbol,
wherein the flexible slot comprises at least one of a downlink symbol, an uplink symbol, and a flexible symbol, and
wherein the downlink symbol is a symbol available for downlink reception, the uplink symbol is a symbol available for uplink transmission, and the flexible symbol is a symbol available for the downlink reception or for the uplink transmission.

8. The UE of claim 1, wherein the information about the slot and the information about the multiple subbands are configured semi-statically.

9. The UE of claim 6, wherein the UE receives dynamic signaling that comprises information for deactivating the multiple subbands and information indicating the type of symbols in the slot,
wherein in case that a slot in which a subband deactivated based on the deactivating information is configured is the downlink slot, the type of symbols in the slot are indicated as a downlink symbol,
wherein when a slot in which a subband deactivated based on the deactivating information is configured is the flexible slot, the type of symbols in the slot is indicated as one of a downlink symbol, an uplink symbol, and a flexible symbol, and
wherein the downlink symbol is a symbol available for downlink reception, the uplink symbol is a symbol available for uplink transmission, and the flexible symbol is a symbol available for the downlink reception or for the uplink transmission.

10. The UE of claim 9, wherein the dynamic signaling comprises information instructing the type of symbol in the slot to be configured as a preconfigured type.

11. A method performed by a UE in a wireless communication system, the method comprising:
receiving information about a slot in a time division duplex (TDD) system;
receiving information about multiple subbands on a frequency domain resource,
wherein the multiple subbands being configured on a frequency domain resource within a predetermined time domain resource of the slot,
wherein the frequency domain resource being included within a carrier bandwidth of the UE,
wherein the information about the slot comprising information indicating a type of symbol in the slot,
wherein the information about the multiple subbands comprising information related to a position of at least one of the multiple subbands in a frequency domain and information related to a type of the at least one subband; and
performing uplink transmission on a resource within a subband determined as a subband for the uplink transmission based on the information about the multiple subbands.

12. The method of claim 11, wherein one subband, among the multiple subbands, is determined as the subband for the uplink transmission based on the information about the multiple subbands.

13. The method of claim 12, wherein the subband determined as the subband for uplink transmission comprises a lowest frequency band or a highest frequency band on the frequency domain resource.

14. The method of claim 12, wherein when the multiple subbands are three or more, the subband determined as the subband for the uplink transmission is positioned between two or more remaining subbands.

15. The method of claim 11, wherein the information about the multiple subbands comprises information about an index of the slot, the number of first RBs constituting a first type of subband, and the number of second RBs constituting a second type of subband,
wherein the first type of subband comprises as many RBs as the number of the first RBs, starting from a first RB in the frequency domain resource of the slot, and
wherein the second type of subband comprises as many RBs as the number of the second RBs, starting from a last RB in the frequency domain resource of the slot.

16. The method of claim 11, wherein the information about the multiple subbands is applied to a slot that is determined as a downlink slot or a flexible slot based on the information about the slot.

17. The method of claim 16, wherein the downlink slot comprises a downlink symbol,
wherein the flexible slot comprises at least one of a downlink symbol, an uplink symbol, and a flexible symbol, and
wherein the downlink symbol is a symbol available for downlink reception, the uplink symbol is a symbol available for uplink transmission, and the flexible symbol is a symbol available for the downlink reception or for the uplink transmission.

18. The method of claim 1, wherein the information about the slot and the information about the multiple subbands are configured semi-statically.

19. The method of claim 17, further comprising receiving dynamic signaling that comprises information for deactivating the multiple subbands and information indicating the type of symbols in the slot,
wherein when a slot in which a subband deactivated based on the deactivating information is configured is the downlink slot, the type of symbols in the slot is indicated as a downlink symbol,
wherein in case that a slot in which a subband deactivated based on the deactivating information is configured is the flexible slot, the type of symbols in the slot is indicated as one of a downlink symbol, an uplink symbol, and a flexible symbol, and
wherein the downlink symbol is a symbol available for downlink reception, the uplink symbol is a symbol available for uplink transmission, and the flexible symbol is a symbol available for the downlink reception or for the uplink transmission.

20. The method of claim 19, wherein the dynamic signaling comprises information instructing the type of symbol in the slot to be configured as a preconfigured type.

21. A base station in a wireless communication system, the base station comprising:
a transceiver; and
a processor configured to control the transceiver,
wherein the processor is configured to:
transmit information about a slot in a time division duplex (TDD) system,
transmit information about multiple subbands on a frequency domain resource,
wherein the multiple subbands being configured on a frequency domain resource within a predetermined time domain resource of the slot,
wherein the frequency domain resource being included within a carrier bandwidth of a UE, the information about the slot comprising information indicating a type of symbol in the slot,
wherein the information about the multiple subbands comprising information related to a position of at least one of the multiple subbands in a frequency domain and information related to a type of the at least one subband, and
perform uplink reception on a resource within a subband determined as a subband for the uplink reception based on the information about the multiple subbands.

22. A method performed by a base station in a wireless communication system, the method comprising:
transmitting information about a slot in a time division duplex (TDD) system;
transmitting information about multiple subbands on a frequency domain resource,
wherein the multiple subbands being configured on a frequency domain resource within a predetermined time domain resource of the slot,
wherein the frequency domain resource being included within a carrier bandwidth of a UE, the information about the slot comprising information indicating a type of symbol in the slot,
wherein the information about the multiple subbands comprising information related to a position of at least one of the multiple subbands in a frequency domain and information related to a type of the at least one subband; and
performing uplink reception on a resource within a subband determined as a subband for the uplink reception based on the information about the multiple subbands.
